(19) United States
(12) Patent Application Publication
(10) Pub. No.: US 2009/0314701 A1
(43) Pub. Date: Dec. 24, 2009

(54) WATER SOFTENER

(75) Inventor: Seung Hoon Jeong, Seoul (KR)

Correspondence Address: RABIN & Berdo, PC, 1101 14TH STREET, NW, SUITE 500, WASHINGTON, DC, 20005, US

(73) Assignee: Seung Gwang Co., Ltd., Incheon (KR)

(21) Appl. No.: 12/307,125

(22) PCT Filed: Oct. 10, 2007
(86) PCT No.: PCT/KR07/04947

§ 371 Date: Dec. 30, 2008

(30) Foreign Application Priority Data
Apr. 11, 2007 (KR) 10-2007-0035704
Oct. 9, 2007 (KR) 10-2007-0101707

(51) Int. Cl. C02F 5/00

(52) U.S. Cl. 210/190

(57) ABSTRACT

This invention provides a water softener for performing a soft water mode to change supplied cold/hot raw water into cold/hot soft water using an ion exchange resin and discharge the cold/hot soft water, a running water mode to discharge the cold/hot raw water as cold/hot running water, a regeneration mode to generate regenerating water by a regeneration material and discharge regeneration waste water generated in regeneration of the ion exchange resin, and a regulation mode to regulate supply of the cold/hot raw water, including: a tank unit; a feed unit; a discharge unit; and a switch valve unit.

### TECHNICAL FIELD

The present invention relates to a water softener, and more particularly, to a water softener which is capable of being stably installed in a bathtube corner in a bathroom without using nails, screws and the like which may do damage to a wall of the bathroom and which is convenient and safe to a user in use by providing not only four basic modes, that is, a soft water mode, a running water mode, a regeneration mode, and a regulation mode, but also various convenience modes and special modes.

### BACKGROUND ART

Living water used in our daily life may be classified into soft water and hard water. Soft water, such as distilled water, which is also called sweet water, having hydrogen (H₂) and oxygen (O₂) as its main components, is relatively pure and feels soft due to its low hardness, while hard water, such as underground water, having calcium ions (Ca²⁺) and magnesium ions (Mg²⁺) besides its main components, feels stiff due to its high hardness.

Nowdays, tap water supplied to most of houses, offices and so on is hard water with high hardness and contains not only chlorine (Cl) used in the process of purification of the tap water but also a quantity of heavy metal ions, such as iron (Fe) ions, copper (Cu) ions, tin (Sn) ions, zinc (Zn) ions, mercury (Hg) ions and so on, which may be produced due to environment pollution and superannuation of water pipes. Although such heavy metal ions are not lethal to a human body, they produces alien substances when combined with fatty acid of soap, and the alien substances are known to be responsible for accelerated skin-aging and skin diseases such as atopy.

Under such circumstances, a water softener has been introduced to change such hard water as tap water into soft water and is being widely used as the most convenient method of obtaining living water of high quality in houses, offices and so on.

The principle of a general water softener to change hard water into soft water is to substitute calcium ions (Ca²⁺) and magnesium ions (Mg²⁺) contained in hard water with sodium ions (Na⁺). For this substitution, an ion exchange resin comprising a special polymer compound containing sodium (Na) as its main component is used. The ion exchange resin absorbs calcium ions (Ca2+) and magnesium ions (Mg2+), and it discharges sodium ions (Na+) instead, when the ion exchange resin contacts the hard water. Therefore, a soft water tank, which is filled with ion exchange resin and into which hard water is introduced to obtain soft water, is indispensable to the water softener.

With repeated softening of hard water into soft water, sodium ions (Na+) of the ion exchange resin are exhausted, which causes its capacity of water softening to be deteriorated, accordingly it is required to regenerate the ion exchange resin. For such regeneration of the ion exchange resin, the water softener uses regeneration material of the ion exchange resin, such as salt or the like, which releases sodium ions (Na+) in an aqueous solution. Accordingly, in a typical water softener, a regeneration tank filled with regeneration material is additionally connected to a soft water tank. When hard water is supplied in the regeneration tank, regeneration water such as salt water containing sodium ions (Na+) or the like is generated and supplied into the soft water tank to regenerate the ion exchange resin, and then is discharged as regeneration waste water.

FIG. 1 is a block diagram of a general water softener, particularly, a cold/hot water softener that changes cold/hot hard water such as tap water into cold/hot soft water depending on temperature of the cold/hot hard water and provide a user with the cold/hot soft water. In the following description, a ‘water softener’ refers to a ‘cold/hot water softener’, and ‘cold/hot hard water’ such as tap water fed into the water softener is called ‘cold/hot raw water’.

As shown in FIG. 1, a general water softener includes first and second soft water tanks 12 and 14, first and second regeneration tanks 22 and 24, a plurality of pipelines 31 to 38, and a plurality of valves V1 to V7.

The first and second soft water tanks 12 and 14 are filled with ion exchange resin, and the first and second regeneration tanks 22 and 24 is filled with regeneration material.

The plurality of pipelines 31 to 38 includes first and second soft water tank feed pipelines 31 and 32 through which cold/hot raw water is fed into the first and second soft water tanks 12 and 14, first and second soft water tank discharge pipelines 33 and 34 through which liquid, for example, cold/hot soft water and regeneration waster water, inside the first and second soft water tanks 12 and 14 is discharged, first and second regeneration tank feed pipelines 35 and 36 through which cold/hot raw water is fed into the first and second regeneration tanks 22 and 24, and first and second regeneration tank discharge pipelines 37 and 38 through which regenerating water produced in the first and second regeneration tanks 22 and 24 is fed into the first and second soft water tanks 12 and 14. The first and second soft water tank feed pipelines 31 and 32 and the first and second regeneration tank feed pipes are connected to a cold/hot water pipe installed in houses, offices and so on.

The plurality of valves V1 to V7 may include first and second valves V1 and V2 that are disposed in the first and second soft water tank feed pipelines 31 and 32 and regulates the cold/hot raw water, a third valve V3 that is disposed to connect with the first and second soft water discharge pipelines 33 and 34 and regulates the cold/hot water and the regeneration waste water discharged from the pipelines 33 and 34, fourth and fifth values V4 and V5 that are disposed in the first and second regeneration tank feed pipelines 35 and 36 and regulates the cold/hot raw water, and sixth and seventh valves V6 and V7 that are disposed in the first and second tank discharge pipelines 37 and 38 and regulates the regenerating water fed into the first and second soft water tanks 12 and 14. Here, the third valve V3 uses a hydrant that controls a mixture ratio of cold/hot raw water based on a level of connection of the first and second soft water discharge pipelines 33 and 34.

When the first and second valves V1 and V2 are opened to feed the cold/hot raw water into the first and second soft water tanks 12 and 14, the cold/hot soft water is produced by an ion exchange action of the ion exchange resin. When the third valve V3 is opened, the cold/hot soft water is discharged externally. In addition, for regeneration of the ion exchange resin exhausted due to repeated water softening, when the fourth and fifth valves V4 and V5 are opened to feed the cold/hot raw water into the first and second regeneration tanks 22 and 24, the regenerating water is produced. When the sixth and seventh valves V6 and V7 are opened to feed the regenerating water into the first and second soft water tanks 12 and 14, the ion exchange resin is regenerated. When the third valve V3 is opened, the regeneration waste water is discharged externally.

However, the above-described general water softener has several demerits as follows.

The way of using the water softener, particularly, the regeneration method of the ion exchange resin is too complicated, which may results in possibility of malfunction or failure of the water softener due to mistaken operation. In addition, since there is no measure to precisely determine a regeneration time of the ion exchange resin, the determination on the regeneration time depends entirely on a user's subjective feeling or rough time calculation. This may result in wastefulness of regeneration material due to frequent unnecessary regeneration, or deterioration of performance and lifetime of the ion exchange resin due to missing of a proper regeneration chance.

Furthermore, in the general water softener, since the specified amount of cold/hot soft water is always stored in the first and second soft water tanks 12 and 14, the temperature of the cold/hot soft water may vary with time, such as being cooled or heated. Accordingly, although the temperature of the cold/hot soft water is fixed by opening the third valve V3 to be adapted for shower or the like, the temperature may be suddenly varied in use of the cold/hot soft water. This may cause a user to be in a danger of scald due to suddenly heated water or to feel unpleasant due to cooled water.

In more detail, in the general water softener, as storage capacity of the first and second soft water tanks 12 and 14 becomes larger, the cold/hot raw water can sufficiently contact with the ion exchange resin, thereby anticipating more effective softening action. Accordingly, the storage capacity of the first and second soft water tanks 12 and 14 typically reaches ten and several litters and the certain amount of the cold/hot soft water is always stored in the first and second soft water tanks 12 and 14. However, if the water softener is not used for a long time, the temperature of the cold/hot soft water stored in the first and second soft water tanks 12 and 14 may be varied such as being cooled or heated. In this condition, if the user opens the third valve V3, the cold/hot soft water stored for a long time in the first and second soft water tanks 12 and 14 is discharged. Accordingly, although the user opens and fixes the third valve V3 based on the temperature, after the cold/hot soft water stored in the first and second soft water tanks 12 and 14 is completely exhausted, new cold/hot soft water by cold/hot raw water newly fed externally is discharged. The temperature of this new cold/hot soft water may be higher or lower than that of the old cold/hot soft water regulated through the third valve V3. Accordingly, the user may undergo sudden change of temperature, such as being heated or cooled, in the use of the cold/hot soft water. This may make the user feel uncomfortable as well as get scalded.

In addition, the general water softener is fixed by nails and screws on walls of bathrooms and so on. As an example, general water softeners disclosed in Korean Utility Model Application Nos. 20-1997-0000006 and 20-2006-0017022, and Korean Patent Application No. 10-1999-0000032 are mounted on separate brackets fixed by nails and screws on walls. However, since a bathroom has a very small space, it is difficult to secure a separate installation space for the water softener. A wall is inevitably damaged due to nails and screws in the course of fixing the brackets, it is difficult to change a position of the water softener after being once fixed, and there is an increasing possibility of deterioration of beauty and water leakage due to holes and clefts of the damaged wall. Moreover, as most of users want to use cold/hot soft water for usual use such as washing and shower, a water softener is typically to be installed in a wall near a bathtube or a washing stand. However, since the wall is also a place where a mirror, a soap stand, a drawer and so on as well as the bathtube and the washing stand are installed, it is difficult to secure an installation space for the water softener. Such difficulty in securing the space greatly limits a range of practical use of the wall in engagement with the above-mentioned problems such as wall damage by nails and screw and difficulty in changing the position of the water softener.

### DISCLOSURE OF INVENTION

### Technical Problem

The present invention has been made to overcome the above-mentioned problems, and it is an object of the invention to provide a water softener which can be conveniently used with simple manipulation.

In particular, it is an object of the invention to provide a water softener which is capable of simply switching and selecting between basic modes used most frequently by a user, that is, a soft water mode for providing cold/hot soft water, a running water mode for providing cold/hot running water as cold/hot hard water, a regeneration mode for regenerating ion exchange resin, and a regulation mode for turning off the water softener, and is capable of providing various special modes for user's convenience and safety.

In addition, it is another object of the invention to provide a water softener which is capable of being stably installed in a bathtube corner in a bathroom without using nails and screws which may do damage to a wall of the bathroom and is capable of being freely changed in its installation position at user's intention, thereby providing high space availability.

### Technical Solution

To achieve the above objects, this invention provides a water softener for performing a soft water mode to change supplied cold/hot raw water into cold/hot soft water using an ion exchange resin and discharge the cold/hot soft water, a running water mode to discharge the cold/hot raw water as cold/hot running water, a regeneration mode to generate regenerating water by a regeneration material and discharge regeneration waste water generated in regeneration of the ion exchange resin, and a regulation mode to regulate supply of the cold/hot raw water, including: a tank unit including a filter tank to filter impurified out of the cold/hot raw water, a soft water tank filled with the ion exchange resin, and a regeneration tank filled with the regeneration material; a feed unit disposed at the bottom of the filter tank for first receiving the cold/hot raw water and feeding the received cold/hot raw water into the filter tank; a discharge unit disposed at the bottom of the soft water tank for finally discharging or regulating the cold/hot soft water, the cold/hot running water and the regeneration waste water; and a switch valve unit for receiving the cold/hot raw water of the filter tank, transferring the received cold/hot raw water to the soft water tank in the soft water mode, transferring the received cold/hot raw water to the discharge unit in the running water mode, transferring the received cold/hot raw water to the regeneration tank and then transferring the regenerating water of the regeneration tank to the soft water tank in the regeneration mode, and regulating supply of the cold/hot raw water in the regulation mode.

### ADVANTAGEOUS EFFECTS

According to the present invention, the water softener has an advantage of simple manipulation and convenient use. That is, the water softener allows simple switching between basic modes used most frequently by a user, that is, a soft water mode for providing cold/hot soft water, a running water mode for providing cold/hot running water as cold/hot hard water, a regeneration mode for regenerating ion exchange ion, and a regulation mode for turning off the water softener, and allows the user to freely select and use a desired mode through simple manipulation of a control valve.

In addition, the water softener of the invention allows a user to use the water softener with safety and convenience by providing a rinsing mode in which the internal pressure of a regeneration tank is lowered and the inside of a soft water tank is rinsed with regenerating water of relatively low concentration, an automatic regeneration mode in which a regeneration time of ion exchange resin is detected based on the supply amount of cold/hot raw water and a regeneration mode is automatically progressed at an appropriate point of time, a flow rate control mode in which a soft water mode and a running water mode are automatically switched to a regulation mode based on the supply amount of cold/hot raw water in order to regulate the discharge amount of cold/hot soft water and cold/hot running water, and a safety mode in which a soft water mode and a running water mode are automatically switched to a regulation mode when the supply temperature of cold/hot raw water is less or more than a reference value in order to protect a user against possible danger.

Furthermore, the water softener of the invention can be stably installed in a bathtube corner in a bathroom or the like without using nails and screws which may do damage to a wall of the bathroom and can be freely changed in its installation position at user's intention, thereby providing high space availability.

### BRIEF DESCRIPTION OF THE DRAWINGS

FIG. 1 is a block diagram of a general water softener.

FIG. 2 is a block diagram of a water softener according to an embodiment of the present invention.

FIGS. 3 and 4 are front and rear perspective views of the water softener according to the embodiment of the present invention.

FIGS. 5 and 6 are partially exploded perspective views of the water softener according to the embodiment of the present invention.

FIG. 7 is an exploded perspective view of a feed unit of the water softener according to the embodiment of the present invention.

FIG. 8 is an exploded perspective view of a discharge unit of the water softener according to the embodiment of the present invention.

FIG. 9 is a partially exploded perspective view of the discharge unit of the water softener according to the embodiment of the present invention.

FIG. 10 is a sectional view taken along line C-C in FIG. 8.

FIG. 11 is an exploded perspective view of a regeneration tank of the water softener according to the embodiment of the present invention.

FIG. 12 is a partial sectional view of the regeneration tank of the water softener according to the embodiment of the present invention.

FIGS. 13 and 14 are a plan view and a bottom view of a tank plate of the water softener according to the embodiment of the present invention, respectively.

FIGS. 15 and 16 are a plan view and a bottom view of a passage plate of the water softener according to the embodiment of the present invention, respectively.

FIG. 17 is an exploded perspective view of a switch valve unit of the water softener according to the embodiment of the present invention.

FIGS. 18 and 19 are a plan view and a bottom view of a fixing disk of the water softener according to the embodiment of the present invention, respectively.

FIG. 20 is a bottom view of a rotating disk of the water softener according to the embodiment of the present invention.

FIGS. 21 to 25 are schematic views illustrating operation modes of the water softener according to the embodiment of the present invention.

FIG. 26 is an exploded perspective view of a filter unit of the water softener according to the embodiment of the present invention.

FIG. 27 is a sectional view taken along line A-A in FIG. 3.

FIG. 28 is a sectional view taken along line B-B in FIG. 6.

FIGS. 29 and 30 are a combined perspective view and an exploded perspective view of a housing of the water softener according to the embodiment of the present invention, respectively.

FIG. 31 is a perspective view of an external appearance of the water softener according to the embodiment of the present invention.

FIG. 32 is an exploded perspective view of an exterior case of the water softener according to the embodiment of the present invention.

FIGS. 33 to 34 are an exploded perspective view and a plan view of a middle case of the water softener according to the embodiment of the present invention.

FIG. 35 is a sectional view taken along line H-H in FIG. 34.

FIG. 36 is an exploded perspective view of a rear case and a hanger of the water softener according to the embodiment of the present invention.

FIG. 37 is a partial sectional view of the rear case and the hanger of the water softener according to the embodiment of the present invention.

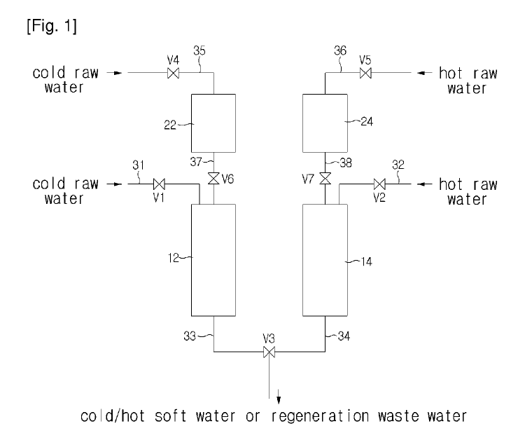

### BEST MODE FOR CARRYING OUT THE INVENTION

Hereinafter, a water softener of the present invention will be described in detail with reference to the accompanying drawings.

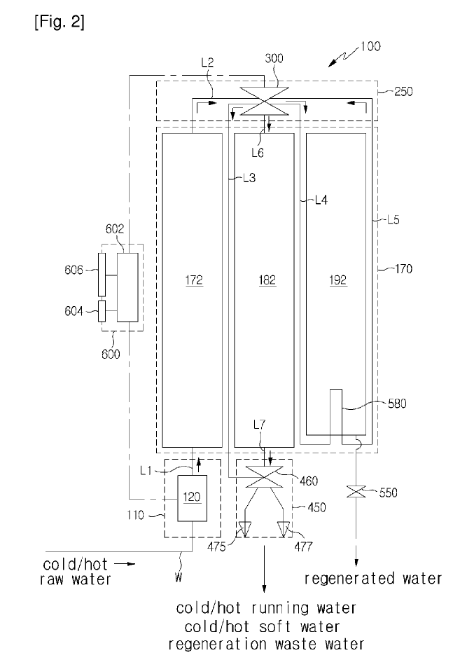

FIG. 2 is a block diagram of a water softener 100 according to an embodiment of the present invention.

As shown in FIG. 2, a water softener 100 according to an embodiment of the present invention includes a feed unit 110, a tank unit 170, a switch valve unit 250, a discharge unit 450, a controller 600, a plurality of pipelines L1 to L7, etc.

The feed unit 110, which is first fed with cold/hot raw water externally. The feed unit 110 is connected, via a separate connecting pipe W, to a hydrant or the like mounted on a wall of a bathroom in a house, and includes a measuring unit 120 for measuring the supply amount and temperature of cold/hot raw water.

The tank unit 170 in which liquid undergoes changes actually includes a filter tank 172 including filter, a soft water tank 182 filled with ion exchange resin, and a regeneration tank 192 filled with regeneration material. Accordingly, when cold/hot raw water is supplied in the filter tank 172, impurities in the water is filtered out, when cold/hot raw water is supplied in the soft water tank 182, the cold/hot raw water is changed into cold/hot soft water, and when cold/hot raw water is supplied in the regeneration tank 192, regenerating water is generated. In addition, when regenerating water is supplied in the soft water tank 182, the regenerating water regenerates the ion exchange resin and then becomes regeneration waste water.

The switch valve unit 250 switches and regulates traveling paths of all liquid in the water softener 100, for example, cold/hot raw water, cold/hot soft water, cold/hot running water, regenerating water, and regeneration waste water, and includes a switch valve assembly 300 for such switch and regulation. Here, ‘cold/hot running water’ refers to ‘cold/hot hard water’ provided from the water softener 100, and is distinguished from ‘cold/hot raw water’ supplied externally for convenience' sake.

The discharge unit 450 finally regulates and discharges the remaining liquid except cold/hot raw water and regenerating water, for example, cold/hot soft water, cold/hot running water, and regeneration waste water, depending on selection of a user, and includes a control valve 460 for finally regulating the liquid or selecting a final discharge point of the liquid according to direct manipulation of a user, and a hydrant 475 and a shower head 477 which are final discharge points of the liquid. Accordingly, the user receives or finally regulates cold/hot soft water and cold/hot running water via one of the hydrant 475 and the shower head 477 by directly manipulating the control valve 460.

The controller 600 controls the switch valve assembly 300 of the switch valve unit 250 to determine and regulate all operation modes of the water softener 100 according to user's intention. The controller 600 includes a logical operating unit 602 such as a microcomputer containing a predetermined algorithm, an input unit 604 such as buttons for input of instructions from a user, a display unit 606 such as an LCD (liquid crystal display) device for displaying various kinds of data.

The plurality of pipelines L1 to L7 are moving paths of various kinds of liquids, and include a filter tank feed pipeline L1 for connecting the feed unit 110 to the filter tank 172 to transfer cold/hot raw water of the feed unit 110 to the filter tank 172, a filter tank discharge pipeline L2 for connecting the filter tank 172 to the switch valve unit 250 to transfer cold/hot raw water of the filter tank 172 to the switch valve assembly 300, a running water pipeline L3 for connecting the switch valve unit 250 to the discharge unit 450 to transfer cold/hot running water of the switch valve assembly 300 to the control valve 460, a regeneration tank feed pipeline L4 for connecting the switch valve unit 250 to the regeneration tank 192 to transfer cold/hot raw water of the switch valve assembly 300 to the regeneration tank 192, a regeneration tank discharge pipeline L5 for connecting the regeneration tank 192 to the switch valve unit 250 to transfer regenerating water of the regeneration tank 192 to the switch valve assembly 300, a soft water tank feed pipeline L6 for connecting the switch valve unit 250 to the soft water tank 182 to transfer cold/hot raw water and regenerating water of the switch valve assembly 300 to the soft water tank 182, and a soft water tank discharge pipeline L7 for connecting the soft water tank 182 to the discharge unit 450 to transfer cold/hot soft water and regeneration waste water of the soft water tank 182 to the control valve 460.

In addition, the regeneration tank 192 of the water softener 100 has a drain valve 550 to forcibly drain regenerating water and a regenerating water generation unit 580 to connect the regeneration tank feed pipeline L4 to the regeneration tank discharge pipeline L5. When cold/hot raw water is supplied to the regenerating water generating unit 580 via the regeneration tank feed pipeline L4, the regenerating water generating unit 580 transfers regenerating water to the regeneration tank discharge pipeline L5.

Based on the prior description, it can be seen that all the components of the water softener 100 except the controller 600 are connected to the switch valve assembly 300 of the switch valve unit 250 via the plurality of pipelines L1 to L7. Accordingly, the switch valve assembly 300 properly interconnect these pipelines L1 to L7 connected thereto, for example, the filter tank discharge pipeline L2, the running water pipeline L3, the regeneration tank feed pipeline L4, the regeneration tank discharge pipeline L5 and the soft water tank feed pipeline L6, thereby switching and regulating traveling paths of all liquids in the water softener 100.

As a result, the water softener 100 provides four basic modes, one special mode, and three convenience modes.

The four basic modes provide the essential functions most frequently used by a user and may be provided with the form of a basic menu selectably by the user through the input unit 604 of the controller 600. The four basic modes include \textcircled{1} a soft water mode in which cold/hot soft water is discharged as cold/hot raw water is fed, \textcircled{2} a running water mode in which cold/hot running water is discharged as cold/hot raw water is fed, \textcircled{3} a regeneration mode in which regenerating water for regeneration of ion exchange resin is generated and regeneration waste water generated in regeneration of ion exchange resin is discharged, and \textcircled{4} a regulation mode in which flow of all liquids including cold/hot raw water is regulated.

In more detail, in the soft water mode, the switch valve assembly 300 connects the filter tank discharge pipeline L2 to the soft water tank feed pipeline L6 to transfer cold/hot raw water of the filter tank 172 to the soft water tank 182. Accordingly, cold/hot soft water is generated in the soft water tank 182 and is transferred to the control valve 460 via the soft water tank discharge pipeline L7. Thus, a user finally regulates discharge of the cold/hot soft water by manipulating the control valve 460 or receives the cold/hot soft water through the hydrant 475 or the shower head 477. In the running water mode, the switch valve assembly 300 connects the filter tank discharge pipeline L2 to the running water pipeline L3 to transfer cold/hot raw water of the filter tank 172 to the control valve 460. Accordingly, a user finally regulates discharge of cold/hot running water by manipulating the control valve 460 or receives the cold/hot running water through the hydrant 475 or the shower head 477. In the regeneration mode, the switch valve assembly 300 connects the filter tank discharge pipeline L2 to the regeneration tank feed pipeline L4 to transfer cold/hot raw water of the filter tank 172 to the regeneration tank 192 and connects the regeneration tank discharge pipeline L5 to the soft water tank feed pipeline L6 to transfer regenerating water of the regeneration tank 192 to the soft water tank 182. Accordingly, ion exchange resin is regenerated in the soft water tank 182, regeneration waste water is transferred to the control valve 460 via the soft water tank discharge pipeline L7, and a user discharges the regeneration waste water to the hydrant 475 by manipulating the control valve 460. At this time, although, if necessary, the user may finally regulate the regeneration waste water or discharge the regeneration waste water through the shower head 477 by manipulating the control valve 460, which is not a normal use mode, he/she typically discharges the regeneration waste water through the hydrant 475. Finally, in the regulation mode, the switch valve assembly 300 blocks the filter tank discharge pipe line L2, thereby regulating flow of all liquids in the water softener 100.

Next, the one special mode is \textcircled{5} a rinsing mode inevitably concomitant in the process of change from the regeneration mode to the regulation mode. In the rinsing mode, the internal pressure of the regeneration tank 192 is lowered and relatively low-densed regenerating water is transferred to the soft water tank 182 to rinse the internal of the soft water tank 182.

To this end, the switch valve assembly 300 regulates the regeneration tank feed pipeline L4 and connects the regeneration tank discharge pipeline L5 to the soft water tank feed pipeline L6 in the process of change from the regeneration mode to the regulation mode. At this time, the regenerating water generation unit 580 mounted on the regeneration tank 192 transfers regenerated water proportional to a feed pressure to the regeneration tank discharge pipeline L5 when cold/hot raw water is fed to the unit 580 via the regeneration tank feed pipeline L4. In this case, in a state where the regeneration tank feed pipeline L4 is regulated, relatively low-densed regenerating water is fed to the soft water tank 182, thereby lowering the internal pressure of the regeneration tank 192 and rinsing regenerating water and regeneration waste water remaining in the ion exchange resin in the soft water tank 182, which will be described in more detail later.

Next, the three convenience modes are unique functions provided by the water softener 100 in order to promote user's convenience and safety, and are performed by the switch valve assembly 300 according to further instructions from a user through the controller 600, based on the four basic modes. In more detail, the three convenience modes include \textcircled{6} an automatic regeneration mode in which a regeneration time of ion exchange resin is detected based on the supply amount of cold/hot raw water measured by means of the measuring unit 120 and the regeneration mode is automatically performed at a proper point of time, \textcircled{7} a flow rate control mode in which the soft water mode or the running water mode is automatically changed to the regulation mode to regulate the discharge amount of cold/hot soft water or cold/hot running water, based on the supply amount of cold/hot raw water measured by means of the measuring unit 120, \textcircled{8} a safety mode in which the soft water mode or the running water mode is automatically changed to the regulation mode to protect a user if the temperature of cold/hot raw water measured by means of the measuring unit 120 is higher or lower than a reference temperature.

In more detail, in the automatic regeneration mode, the controller 600 calculates and stores the regeneration time of the ion exchange resin based on the supply amount of cold/hot raw water measured in the soft water mode and causes the switch valve assembly 300 to perform the regeneration mode when the regeneration time comes. In the flow rate control mode, the controller 600 compares a flow amount instructed by a user through the input unit 604 with the supply amount of cold/hot raw water measured in the soft water mode or the running water mode, and if they match each other, causes the switch valve assembly 300 to perform the regulation mode. In the safety mode, the controller 600 compares the reference temperature inputted or preset through the input unit 604 with the temperature of cold/hot raw water measured in the soft water mode or the running water mode, and if the measured temperature of cold/hot raw water is higher or lower than the reference temperature, causes the switch valve assembly 300 to perform the regulation mode.

Hereinafter, the configuration of the water softener according to an preferred embodiment of the present invention will be described in detail with reference to relevant figures based on FIG. 2. Throughout the accompanying drawings, the like elements are denoted by the like reference numerals, and repeated explanation thereof will be omitted. In the above description, moving paths of liquid are conveniently called pipeline, but may have the form of a tube or a passage or other forms properly defined in the water softener 100, and further may share some or all of one tube or passage, which will be described in detail in relevant portions of the description.

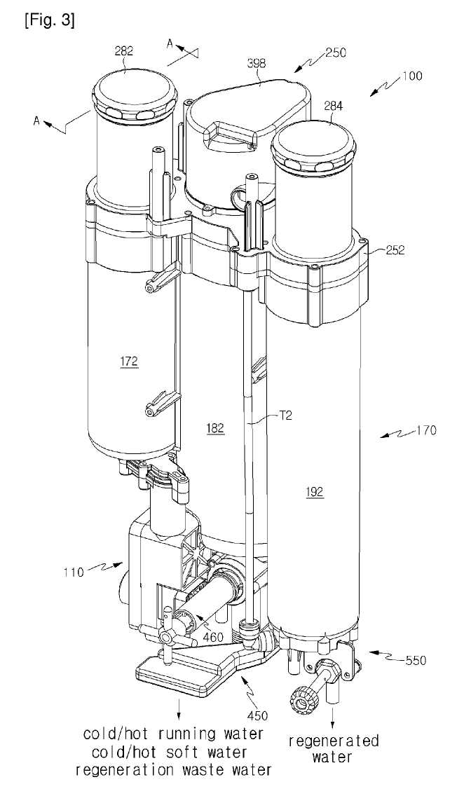

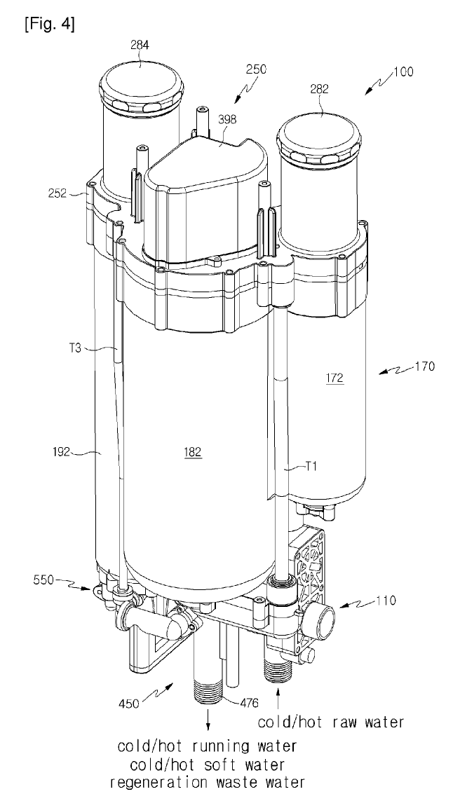

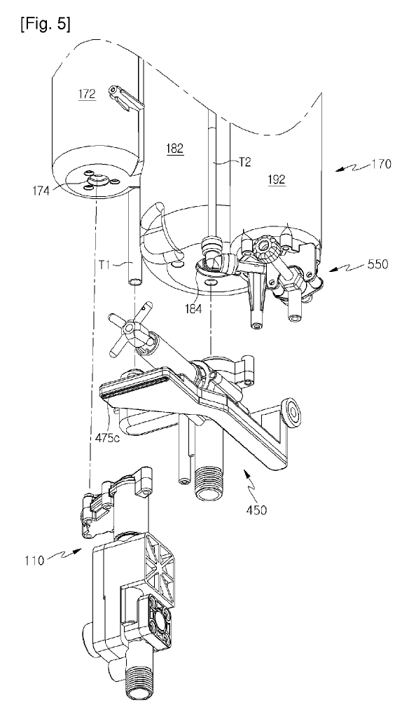

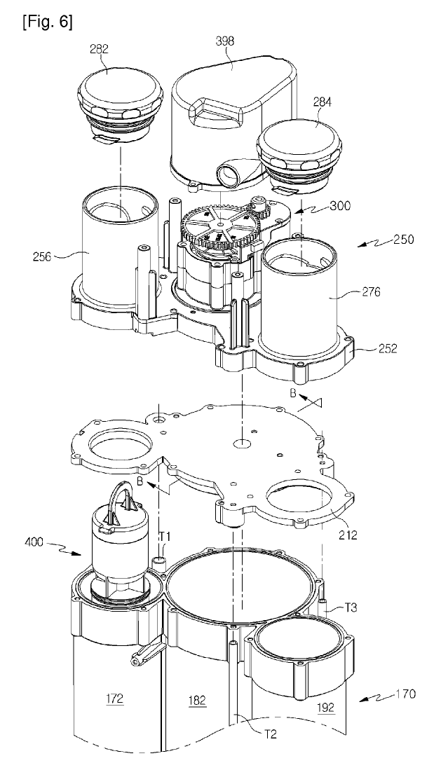

FIGS. 3 and 4 are front and rear perspective views of the water softener 100 according to the embodiment of the present invention, respectively. FIGS. 5 and 6 are exploded top and bottom perspective views of the water softener 100 according to the embodiment of the present invention, respectively. For convenience' sake, the controller (600 in FIG. 2) is not shown in these figures, but will be described in detail in relevant portions.

As shown in these figures, the water softener 100 of the invention includes the feed unit 110, the tank unit 170, switch valve unit 250, and the discharge unit 450, with the feed unit 110 and the discharge unit 450 combined to the bottom of the tank unit 170 and with the switch valve unit 250 combined to the top of the tank unit 170.

The tank unit 170 includes the soft water tank 182, and the filter tank 172 and the regeneration tank 192 which are disposed in parallel at the left and right sides of the soft water tank 182, respectively, showing triangular arrangement as a whole.

A filter tank feed hole 174 passes through the bottom of the filter tank 172 and is connected with the feed unit 110. Accordingly, external cold/hot raw water is transferred to the filter tank 172 via the feed unit 110 and subsequently the filter tank feed hole 174, and a filter unit 400 contained in the filter tank 172 filters impurities out of the cold/hot raw water passing through the filter tank 172. A soft water tank discharge hole 184 passes through the bottom of the soft water tank 182 and is connected with the discharge unit 450. The discharge unit 450 is separately connected to a running pipe T1, and accordingly, cold/hot soft water and regeneration waste water of the soft water tank 182 and cold/hot running water of the switch valve assembly 300 are transferred to the discharge unit 450. A drain valve 550 is disposed on the bottom of the regeneration tank 192.

Tops of the filter tank 172, soft water tank 182 and regeneration tank 192 of the tank unit 170 are sealed with a tank plate 212 formed with a plurality of tank holes connected respectively to the filter tank 172, the soft water tank 182, the regeneration tank 192, the running pipe T1, a regeneration tank feed pipe T2 and a regeneration tank discharge pipe T3.

The switch valve unit 250 connected to the top of the tank unit 170 includes a passage plate 252 adhered closely to the tank plate 212, the switch valve assembly 300 mounted on the top of the passage plate 252, and a switch valve cover 398 covering the switch valve assembly 300. A filter tank flange 256 and a regeneration tank flange 276 provided on the top of the passage plate 252 are respectively connected to the filter tank 172 and the regeneration tank 192 via the tank plate 212 and respectively join with a filter tank cap 282 and a regeneration tank cap 284 to be opened depending on user's selection.

The running water pipe T1 connecting the passage plate 252 to the discharge unit 450 via the tank plate 212 is disposed between the filter tank 172 and the soft water tank 182 at the rear side of the water softener 100, the regeneration tank feed pipe T2 connecting the passage plate 252 to the bottom of the regeneration tank 192 via the tank plate 212 is disposed between the soft water tank 182 and the regeneration tank 192 at the front side of the water softener 100, and the regeneration tank discharge pipe T3 connecting the passage plate 252 to the bottom of the regeneration tank 192 via the tank plate 212 is disposed between the soft water tank 182 and the regeneration tank 192 at the rear side of the water softener 100. The running water pipe T1, as a part of the running water pipeline L3 shown in FIG. 2, transfers cold/hot raw water of the switch valve assembly 300 to the regeneration tank 192, the regeneration tank feed pipe T2, as a part of the regeneration tank feed pipeline L4 shown in FIG. 2, transfers cold/hot raw water of the switch valve assembly 300 to the regeneration tank 192, and the regeneration tank discharge pipe T3, as a part of the regeneration tank feed pipeline L5 shown in FIG. 2, transfers regenerating water of the regeneration tank 192 to the switch valve assembly 300.

Although not definitely shown in the figures, the passage plate 252 is formed with a plurality of passage holes connected to the switch valve assembly 300, a plurality of passages connecting the tank holes to the passage holes are defined between the tank plate 212 and the passage plate 252 by close adhesion therebetween, the switch valve assembly 300 interconnects the plurality of passage holes in accordance with a rule using rotatory power of a motor.

As a result, the switch valve assembly 300 can switch and control all operation modes of the water softener, which will be later described in relevant portions. Flow of liquid for the four basic modes may be summarized as follows. In the following summarization, parentheses denote the kind of liquid in corresponding steps, and a point where cold/hot raw water is changed to cold/hot running water is referred to as the switch valve assembly 300 for convenience' sake.

(1) Soft water mode: feed unit 110 (cold/hot raw water)→filter tank 172 (cold/hot raw water)→tank plate 212 (cold/hot raw water)→passage plate 252 (cold/hot raw water)→switch valve assembly 300 (cold/hot raw water)→passage plate 252 (cold/hot raw water)→tank plate 212 (cold/hot raw water)→soft water tank 182 (cold/hot soft water)→soft water tank discharge hole 184 (cold/hot soft water)→discharge unit 450 (cold/hot soft water)

(2) Running water mode: feed unit 110 (cold/hot raw water)→filter tank 172 (cold/hot raw water)→tank plate 212 (cold/hot raw water)→passage plate 252 (cold/hot raw water)→switch valve assembly 300 (cold/hot running water)→passage plate 252 (cold/hot running water)→tank plate 212 (cold/hot running water)→running water pipe T1 (cold/hot running water)→discharge unit 450 (cold/hot running water)

(3) Regeneration mode: feed unit 110 (cold/hot raw water)→filter tank 172 (cold/hot raw water)→tank plate 212 (cold/hot raw water)→passage plate 252 (cold/hot raw water)→switch valve assembly 300 (cold/hot raw water)→passage plate 252 (cold/hot raw water)→tank plate 212 (cold/hot raw water)→regeneration tank feed pipe T2 (cold/hot raw water)→regeneration tank 192 (regenerating water)→regeneration tank discharge pipe T3 (regenerating water)→tank plate 212 (regenerating water)→passage plate 252 (regenerating water)→switch valve assembly 300 (regenerating water)→passage plate 252 (regenerating water)→tank plate 212 (regenerating water)→soft water tank 182 (regeneration waste water)→soft water tank discharge hole 184 (regeneration waste water)→discharge unit 450 (regeneration waste water)

(4) Regulation mode: feed unit 110 (cold/hot raw water)→filter tank 172 (cold/hot raw water)→tank plate 212 (cold/hot raw water)→passage plate 252 (cold/hot raw water)→switch valve assembly 300 (cold/hot raw water)→regulation

Hereinafter, detailed configuration of the water softener will be described.

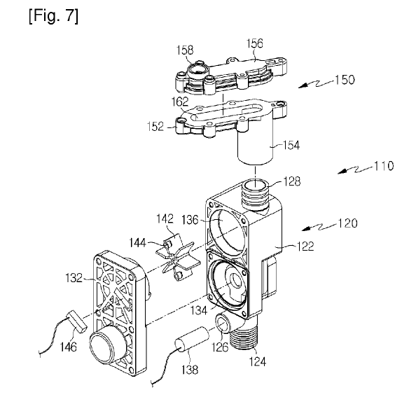

FIG. 7 is an exploded perspective view of the feed unit 110

As shown in the figure, the feed unit 110 may include the measuring unit 120 for measuring the supply amount and temperature of cold/hot raw water supplied externally, and a raw water feed frame 150 for transferring the cold/hot raw water of the measuring unit 120 to the filter tank feed hole (174 in FIG. 5) of the filter tank (172 in FIG. 5).

The measuring unit 120 may also play a role in controlling the supply amount of cold/hot raw water. To this end, the measuring unit 120 includes a body housing 122 provided with a lower inlet port 124 and an upper outlet port 128, and a cover housing 132 covering one side of the body housing 132. The inlet port 124 is connected to a hydrant installed in a bathroom or the like, and the outlet port 128 is connected to the filter tank feed hole 174 of the filter tank 172 via the raw water feed frame 150. A pressure reducing space 134 and a flow rate measuring space 136 connecting the inlet port 124 to the outlet port 128 are defined by the body housing 122 and the cover housing 132 by combination therebetween. A sensor bracket 126 in which a temperature sensor 138 is inserted is provided in one of the inlet port 124 and the outlet port 128, for example, in the inlet port 124. A pressure reducing valve (not shown) using a diaphragm or the like is mounted in the pressure reducing space 134, and an impeller 142 attached with one or more magnets 144 is mounted in the flow rate measuring space 136. A counter 146 such as a lead switch to count the rotation number of the impeller 142 depending on proximity of the magnets 144 attached to the impeller 142 is attached to the cover housing 132.

As a result, cold/hot raw water supplied to the inlet port 124 of the measuring unit 120 is transferred to the outlet port 128 via the pressure reducing space 134 and subsequently the flow rate measuring space 136. Temperature of the cold/hot raw water is measured by the temperature sensor 138 in direct contact with the temperature sensor 138 in the course of passing through the inlet port 124, pressure of the cold/hot raw water is controlled to be a constant value by actuation of the pressure reducing valve in the course of passing through the pressure reducing space 134, and the cold/hot raw water rotates the impeller 142 in the course of passing through the flow rate measuring space 136. In this time, the rotation number of the impeller 142 is counted by the counter 146, with a counting result indicating the supply amount of the cold/hot raw water. For reference, although different in detailed shape, details of the measuring unit 120 are disclosed in Korean Patent Application Nos. 10-2004-50984 and 10-2004-15194, both of which are owned by the present applicant.

The cold/hot raw water that passed through the measuring unit 120 is supplied to the filter tank feed hole 174 of the filter tank 172 via the raw water feed frame 150. As a result, the raw water feed frame 150 substantially becomes the regeneration tank feed pipeline L1 shown in FIG. 2. To this end, the raw water feed frame 150 includes a lower first sub raw water feed frame 152 and an upper second sub raw water feed frame 156. The first sub raw water feed frame 152 is provided with a first raw water connection port 154 connected to the outlet port 128 of the measuring unit 120, and the second sub raw water feed frame 156 is provided with a second raw water connection port 158 connected to the filter tank feed hole 174 of the filter tank 172. A raw water feed passage 162 connecting the first sub raw water connection port 154 to the second raw water connection port 158 is defined by combination of the first and second raw water feed frames 152 and 156.

Accordingly, the cold/hot raw water that passed through the measuring unit 120 is transferred to the filter tank 172 via the filter tank feed hole 174 after it passes through the first raw water feed frame 154, the raw water feed passage 162 and the second raw water connection port 158 in the order named. If necessary, instead of the raw water feed frame 150, the outlet port 128 of the measuring unit 120 may be directly connected to the filter tank feed hole 174 of the filter tank 172.

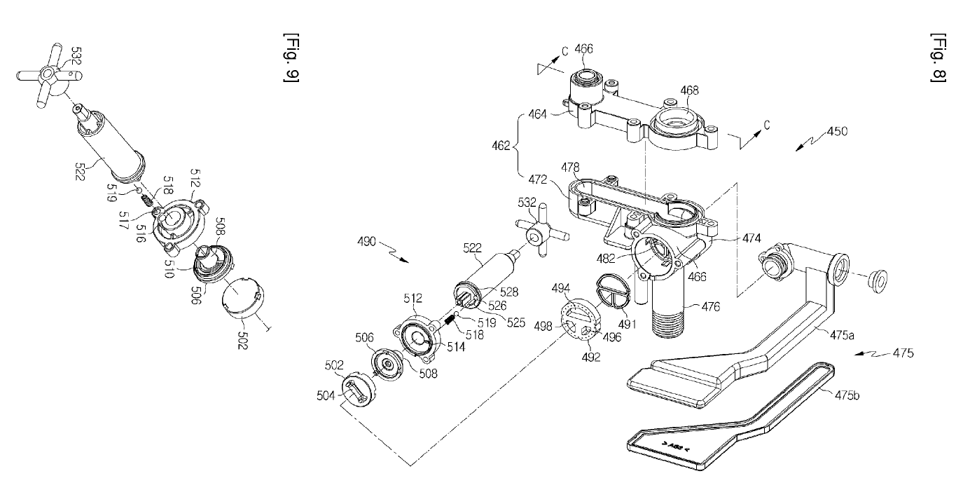

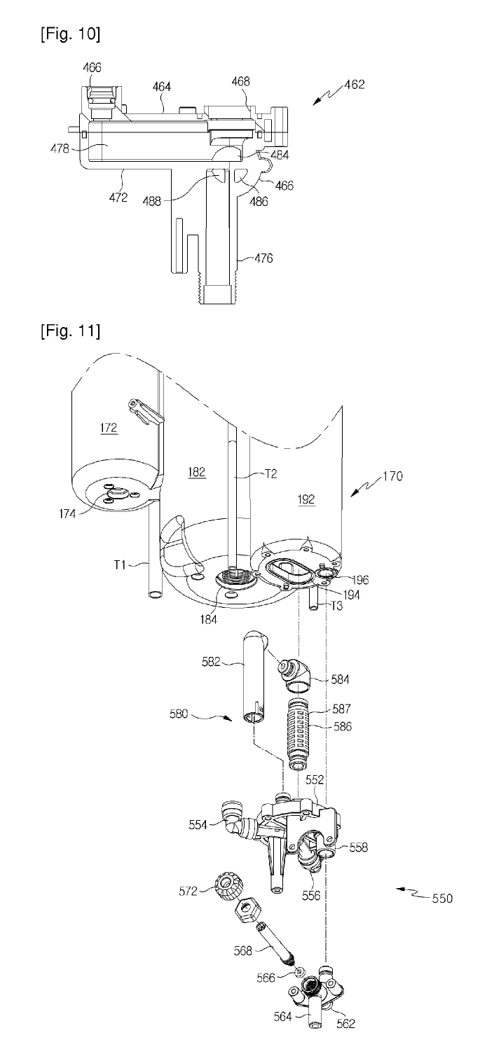

FIG. 8 is an exploded perspective view of the discharge unit 450, FIG. 9 is a partially exploded perspective view of a portion of the discharge unit 450 when viewed in a different direction, and FIG. 10 is a sectional view taken along line C-C in FIG. 8.

As shown in these figures, the discharge unit 450 includes a control valve 490 including a control valve frame 462, and the hydrant 475 and the shower head (477 in FIG. 2) connected to the control valve 490.

The control valve frame 462 may include a first sub control valve frame 464 combined to the bottom of the soft water tank (182 in FIG. 3), and a second sub control valve frame 472 combined to the bottom of the first sub control valve frame 464. The first sub control valve frame 464 is provided with a running water connection port 466 connected to the running water pipe (T1 in FIG. 3) and a soft water tank connection port 468 connected to the soft water tank discharge hole (184 in FIG. 3), and the second sub control valve frame 472 is provided with a hydrant connection port 474 connected to the hydrant 475 and a shower head connection port 476 connected to the shower head 477. Separately, one side of the second sub control valve frame 472 is provided a control valve housing 466 providing a circular planar control valve sheet 482 formed with first to third control valve holes 484, 486 and 488, and a control valve passage 478 interconnecting the running water connection port 466, the soft water tank connection port 468 and the first control valve hole 484 is defined between the first and second sub control valve frames 464 and 472 by combination therebetween. The second control valve hole 486 is connected to the hydrant connection port 474, and the third control valve hole 488 is connected to the shower head connection port 476.

In the control valve housing 466 are inserted a control valve fixing disk 492 fixed closely to the control valve sheet 482 via a control valve packing 491, a control valve rotating disk 502 rotatably adhered closely to the control valve fixing disk 492, and a control valve bracket 506 having a control valve rotating axis 508 drawn out of the control valve housing 466, with the control valve rotating axis 508 fixed to the control valve rotating disk 502. The control valve rotating axis 508 of the control valve bracket 506 has the same axis as the control valve fixing disk 492 and the control valve rotating disk 502. The control valve fixing disk 492 is formed with first to third control valve fixing holes 494, 496 and 498 respectively corresponding to the first to third control valve holes 484, 486 and 488, and the control valve rotating disk 502 is provided with a groove-shaped control valve rotating passage 504 rotating in such a manner that it communicates the first control valve fixing hole 494 to one or both of the second and third control valve fixing holes 496 and 498 or blocking the first control valve fixing hole 494. In this case, the blocking of the first control valve fixing hole 494 by the control valve rotating passage 504 means that the first control valve fixing hole 494 is connected to none of the second and third control valve fixing holes 496 and 498. A control valve cover 512 to cover and seal the control valve bracket 506 except the control valve rotating axis 508 is fixedly combined to the control valve housing 466, a control valve rotating shaft 522 is combined to the control valve rotating axis 508 of the control valve bracket 506 which is drawn out of the control valve cover 512, and a control handle 532, which is rotated by hand of a user, is combined to the control valve rotating shaft 522. When the control handle 532 is rotated, the control valve rotating shaft 522, the control valve bracket 506 and the control valve rotating disk 502 are rotated together.

Accordingly, when the control valve rotating passage 504 of the control valve rotating disk 502 connects the first control valve fixing hole 494 to the second control valve fixing hole 496 of the control valve fixing disk 492 by rotation of the control handle 532, cold/hot running water, cold/hot soft water and regeneration waste water, which are transferred to the control valve passage 478 via the running water connection port 466 and the soft water tank connection port 468, are discharged to the hydrant connection port 474. When the control valve rotating passage 504 connects the first control valve fixing hole 494 to the third control valve fixing hole 498 of the control valve fixing disk 492, cold/hot running water, cold/hot soft water and regeneration waste water, which are transferred to the control valve passage 478 via the running water connection port 466 and the soft water tank connection port 468, are discharged to the shower head connection port 476. When the control valve rotating passage 504 of the control valve rotating disk 502 blocks the first control valve fixing hole 494 of the control valve fixing disk 492, cold/hot running water, cold/hot soft water and regeneration waste water, which are transferred to the control valve passage 478 via the running water connection port 466 and the soft water tank connection port 468, are finally regulated. At this time, if necessary, the first to third control valve fixing holes 494, 496 and 498 may be connected together by properly adjusting the shape or size of the control valve rotating passage 504. In this case, cold/hot running water, cold/hot soft water and regeneration waste water, which are transferred to the control valve passage 478 via the running water connection port 466 and the soft water tank connection port 468, are discharged via both of the hydrant connection port 474 and the shower head connection port 476.

As a result, through simple manipulation to rotate the control valve 532, the control valve 490 can regulate all of the cold/hot running water, cold/hot soft water and regeneration waste water, which are transferred from the running water pipe T1 and the soft water tank 182, or discharge these water via one or both of the hydrant 475 and the shower head 477.

In particular, on an outer side of the control valve cover 512 of the control valve 490 is provided a separate mount hole 517 in which a spring 518 and a ball stopper 519 are inserted. Also, on one side of the control valve rotating shaft 522 facing the control valve cover 512 are provided an arc-like guide groove 525 to guide the ball stopper 519 and stopper grooves 526 formed in the middle of the guide groove 525. Accordingly, when a user turns the control handle 532, the ball stopper 519 is temporarily caught by the stopper grooves 526 in the course of movement along the guide groove 525, thereby guiding a user to a correct stop position of the control handle 532. Here, the correct stop position of the control handle 532 may be a point at which cold/hot running water, cold/hot soft water and regeneration waste water are discharged to the hydrant connection port 474, a point at which cold/hot running water, cold/hot soft water and regeneration waste water are discharged to the shower head connection port 476, a point at which cold/hot running water, cold/hot soft water and regeneration waste water are regulated, and a point at which cold/hot running water, cold/hot soft water and regeneration waste water are discharged to both of the hydrant connection port 474 and the shower head connection port 476. In addition, a first hook-like stopper projection 514 is provided in an inner side of the control valve cover 512 sealing the control valve housing 466, and a first arc-like stopper guide 510 with its one side opened is provided in one side of the control valve bracket 506 opposing the control valve cover 512, so that the control handle 532 and the control valve rotating disk 502 can be rotated only in a specified radius. In addition, a second hook-like stopper projection 516 is provided in an outer side of the control valve cover 512, and a second arc-like stopper guide 528 with its one side opened is provided in one side of the control valve rotating shaft 522 opposing the control valve cover 512, so that the control handle 532 and the control valve rotating disk 502 can be rotated only in a specified radius. Here, when the first and second stopper projections 514 and 516 and the first and second stopper guides 508 and 528 are all used, double stopper action may be obtained, thereby preventing the control valve rotating disk 502 from being rotated over a permitted path even when a user turns the control valve 532 with excessive force.

The hydrant 475 may include a first sub hydrant frame 475a connected to the hydrant connection port 474 and a second hydrant frame 475b connected to the bottom of the first sub hydrant frame 475a and defining a hydrant space connected to the hydrant connection port 474 between the first and second sub hydrant frames 475a and 475b. On the bottom of one side of the second sub hydrant frame 475b is provided an ejection port (see 475c in FIG. 5) through which cold/hot running water and cold/hot soft water are supplied to a user or are discharged.

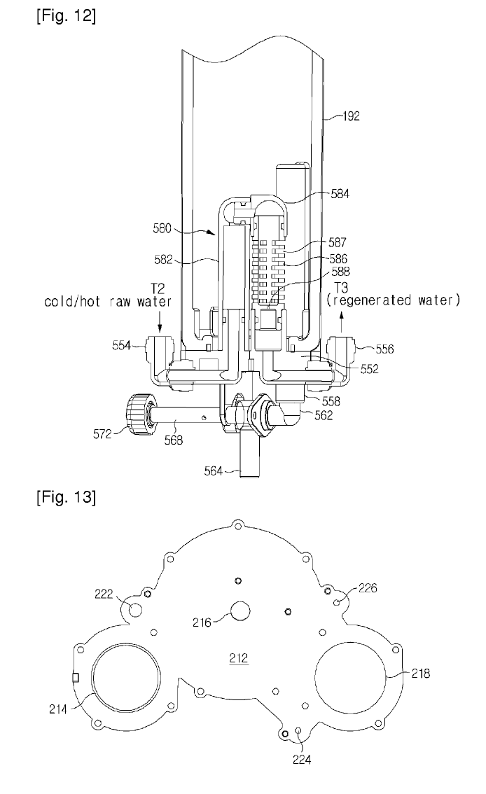

FIG. 11 is an exploded perspective view of the regeneration tank 192 and FIG. 12 is a partial sectional view of the regeneration tank 192, showing detailed configuration of the drain valve 550 and the regenerating water generation unit 580.

As shown in the figures, a regenerating water hole 194 and a drain hole 196 are formed in the bottom of the regeneration tank 192. The regenerating water hole 194 connects the regeneration tank feed pipe T2 and the regeneration tank discharge pipe T3 to the regenerating water generation unit 580 mounted on the regeneration tank 192, and the drain hole 196 is connected to the drain valve 550. If necessary, as shown in the figures, instead of sealing the bottom of the regeneration tank 192 by the regeneration plate 552, first and second fittings 554 and 556 connected respectively to the regeneration tank feed pipe T2 and the regeneration tank discharge pipe T3 and a drain valve hole 558 connected to the drain hole 196 may be formed in the regeneration tank plate 552. Accordingly, the drain valve 550 is mounted in the drain valve hole 558 at the bottom of the regeneration tank plate 552, and the regenerating water generation unit 580 interconnecting the regeneration tank feed pipe T2 and the regeneration tank discharge pipe T3 is disposed on the top of the regeneration tank plate 552 via the first and second fittings 554 and 556 and is inserted in the regeneration tank 192.

The drain valve 550 forcibly drains the regenerating water in the regeneration tank 192 by direct manipulation of a user.

To this end, the drain valve 550 includes a drain valve housing 562 connected to the drain valve hole 558 for providing a separate drain outlet 564, a drain valve shaft 568 screwed in the drain valve housing 562 and moved backward, and a drain handle 572 fixed to an end of the drain valve shaft 568. A valve hole (not shown) connecting the drain valve 558 to the drain outlet 564 is provided within the drain valve housing 562, and a drain valve packing 566 opening/closing the valve hole of the drain valve shaft 568 is mounted in an end of the drain valve shaft 568 inserted in the drain valve housing 562. Accordingly, when a user turns the drain handle 572 in one direction, the drain valve shaft 568 and the drain valve packing 566 are moved forward (or backward) to close the valve hole. When the user turns the drain handle 572 in the opposite direction, the drain valve shaft 568 and the drain valve packing 566 are moved backward (or forward) to open the valve hole. When the valve hole is opened, the regenerating water in the regeneration tank 192 is discharged to the outside via the drain outlet 564. Accordingly, the user can freely drain the regenerating water in the regeneration tank 192. The corresponding function is used to prevent eruption of the regenerating water by draining the regenerating water in the regeneration tank 192 beforehand before opening the regeneration tank cap (see 284 in FIG. 3) to inject, replace or supplement regeneration material.

Next, when cold/hot raw water is fed into the regenerating water generation unit 580 via the regeneration tank feed pipe T2, the regenerating water generation unit 580 transfers the regenerating water via the regeneration tank discharge pipe T3.

To this end, the regenerating water generation unit 580 has the form of a U-like tube and may include a first pipe 582 connected to the regeneration tank feed pipe T2, a second pipe 586 connected to the regeneration tank discharge pipe T3, and a connection pipe 584 interconnecting the first and second pipes 582 and 586. The second pipe 586 has the form of a mesh formed with a plurality of fine holes 587. A through hole 588 to suddenly decrease the inner diameter of the second pipe 586 is provided in the second pipe 586 corresponding to the bottom of the regeneration tank 192. As a result, cold/hot raw water transferred to the regeneration tank feed pipe T2 is introduced into the regeneration tank 192 via the fine holes 587 of the second pipe 586 and is changed to regenerating water which is in turn transferred to the regeneration tank discharge pipe T3 via the fine hole 587 of the second pipe 586.

In more detail, assuming that the regenerating water is filled with the regeneration tank 192 at a level above the regenerating water generation unit 580, the cold/hot raw water transferred to the regeneration tank feed pipe T2 causes an abrupt vortex flow near the through hole 588 to suddenly decrease the inner diameter of the second pipe 586 immediately before being introduced in the through hole 588 through the first pipe 582, the connection pipe 584 and the second pipe 586. Accordingly, the regenerating water in the regeneration tank 192 is introduced into the second pipe 586 and is discharged to the regeneration tank discharge pipe T3 via the through hole 588. At this time, as the supply pressure of the cold/hot raw water transferred to the regeneration tank feed pipe T2 becomes higher, a stronger vortex flow occurs, and thus, higher-densed regenerating water is transferred to the regeneration tank discharge pipe T3. Accordingly, the supply pressure of the cold/hot raw water transferred via the regeneration tank feed pipe T2 is proportional to the density of regenerating water introduced into the regeneration tank discharge pipe T3.

Hitherto, the feed unit 110, the discharge unit 450, the drain valve 550 and the regenerating water generation unit 580 have been described in detail. Hereinafter, detailed configuration and operation of the tank plate 212 and the switch valve assembly 300 and switch and regulation of liquids for each operation mode of the water softener of the invention will be described.

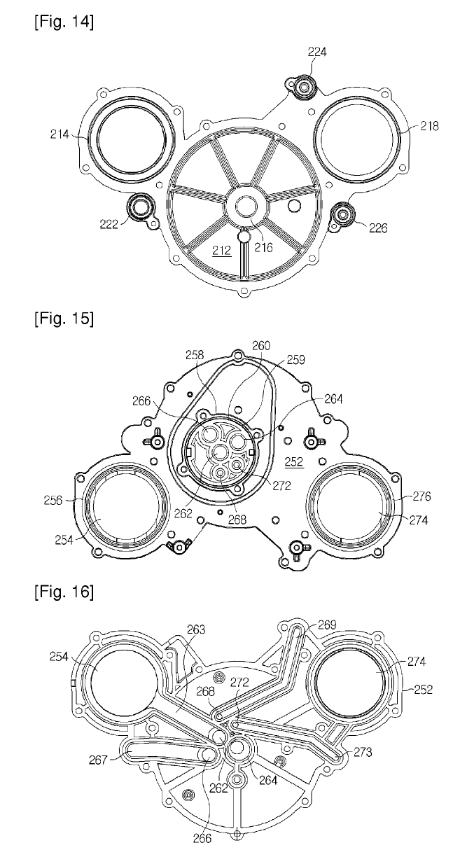

FIGS. 13 and 14 are a plan view and a bottom view of the tank plate 212 sealing the top of the tank unit 170 of the water softener of the present invention, respectively.

As shown in the figures, the tank plate 212 is formed with a first tank hole 214 connected to the filter tank (see 172 in FIG. 6), a second tank hole 216 connected to the soft water tank (see 182 in FIG. 6), a third tank hole 218 connected to the regeneration tank (see 192 in FIG. 6), a fourth tank hole 222 connected to the running water pipe (see T1 in FIG. 6), a fifth tank hole 224 connected to the regeneration tank feed pipe (see T2 in FIG. 6), and a sixth tank hole 226 connected to the regeneration tank discharge pipe (see T3 in FIG. 6).

FIGS. 15 and 16 are a plan view and a bottom view of the passage plate 252 of the switch valve unit 250 adhered closely to the tank plate 212, respectively. Reference is made to FIGS. 15 and 16 in conjunction with FIGS. 13 and 14.

As shown in these figures, the passage plate 252 is formed with first to seventh passage holes 254, 262, 264, 266, 268, 272 and 274, and first to fourth passage grooves 263, 267, 269 and 273 are formed in the bottom of the passage plate 252. The first to fourth passage grooves 263, 267, 269 and 273 are adhered closely to the tank plate 212 to define first to fourth passages 263, 267, 269 and 273. The first passage 263 interconnects the first tank hole 214, the first passage hole 254 and the second passage hole 262, the second passage 267 interconnects the fourth tank hole 222 and the fourth passage hole 266, the third passage 269 interconnects the fifth tank hole 224 and the fifth passage hole 268, and the fourth passage 273 interconnects the sixth tank hole 226 and the sixth passage hole 272. The third passage hole 264 is directly connected to the second tank hole 216, and the seventh passage hole 274 is directly connected to the third tank hole 218. In addition, a valve region 260 provided with a circular planar valve sheet 259 is defined on the top of the passage plate 252 by a cylinder-like valve housing 258, and the second to sixth passage holes 262, 264, 266, 268 and 272 are properly disposed on the valve sheet 259.

Considering a connection relationship based on the second to sixth passage holes 262, 264, 266, 268 and 272, the second passage hole 262 is connected to the filter tank 172 as it is connected to the first passage hole 254 and the first tank hole 214 via the first passage 263, the third passage hole 264 is connected to the soft water tank 182 via the second tank hole 216, the fourth passage hole 266 is connected to the running water pipe T1 as it is connected to the fourth tank hole 222 via the second passage 267, the fifth passage hole 268 is connected to the regeneration tank feed pipe T2 as it is connected to the fifth tank hole 224 via the third passage 269, and the sixth passage hole 272 is connected to the regeneration tank discharge pipe T3 as it is connected to the sixth tank hole 226 via the fourth passage 273.

Accordingly, a connection relationship may be established as shown below

<Connection Relationship>

(1) Second passage hole 262-filter tank 172

(2) Third passage hole 264-soft water tank 182

(3) Fourth passage hole 266-running water pipe T1

(4) Fifth passage hole 268-regeneration tank feed pipe T2

(5) Sixth passage hole 272-regeneration tank discharge pipe T3

As a result, when the second to sixth passage holes 262, 264, 266, 268 and 272 disposed on the valve sheet 259 of the passage plate 252 are properly connected, moving paths of liquids for each operation mode of the water softener can be expected to be switched and regulated. To this end, the switch valve assembly 300 is mounted on the valve region. For reference, the first tank hole 214 and the first passage hole 254, which are located in the filter tank flange 256, function as an inlet of the filter tank 172 and simultaneously connect the filter tank 172 to the second passage hole 262 via the first passage 263, while the third tank hole 218 and the seventh passage hole 274, which are located in the regeneration tank flange 276, functions as only an inlet of the regeneration tank 192.

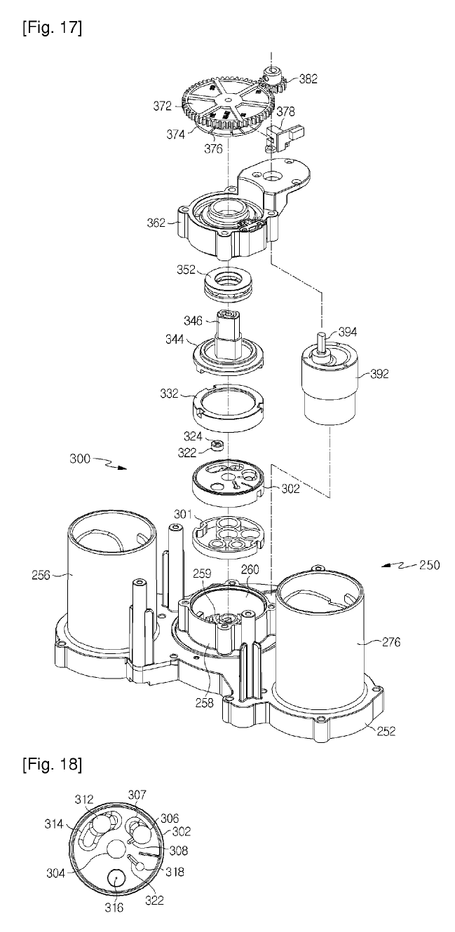

FIG. 17 is an exploded perspective view of the switch valve assembly 300.

As shown in this figure, the switch valve assembly 300 includes a motor 392 mounted on the top of the passage plate 252 in the outside of the valve region 260, a fixing disk 302 fixed closely on the top of the valve sheet 259 via a switch valve packing 301, a rotating disk 332 rotatably adhered closely on the top of the fixing disk 302, a disk bracket 344 combined to the rotating disk 332 to provide a rotation axis 346 passing the center of the rotating disk 332, a valve cover 362 combined to the valve housing 258 via a ball bearing 352, covering the valve region 260 and exposing the rotation axis 346 of the disk bracket 344 and a motor shaft 394 of the motor 392, a driven gear 372 mounted on the valve cover 362 and fixed to the rotation axis 346 of the disk bracket 344, a rotating flange 374 fixed to the rotation axis 346 of the disk bracket 344 between the driven gear 372 and the valve cover 362 and provided with a plurality of indication grooves 376 along an edge of the rotating flange 374, an optical sensor 378 fixed to the valve cover 362 to identify the indication grooves 376 of the rotating flange 374, and a driving gear 382 mounted on the valve cover 362 in engagement with the driven gear 372 and fixed to the motor shaft 394 of the motor 392. Accordingly, when the motor shaft 394 of the motor 392 is rotated, the driving gear 382, the driven gear 372, the rotating flange 374, the disk bracket 344 and the rotating disk 332 are rotated.

The fixing disk 302 is formed with a plurality of fixing holes respectively corresponding to the second to sixth passage holes (see 262, 264, 266, 268 and 272 in FIG. 15), and a rotating passage connecting one or more selected from the plurality of fixing holes for each operation mode of the water softener by rotation of the rotating disk 332 is provided in an adhesion surface of the rotating disk 332. In addition, in this course, the optical sensor 378 fixed to the valve cover 362 can detect a degree of rotation of the rotation disk 302 through the indication groove 376 of the rotating flange 374.

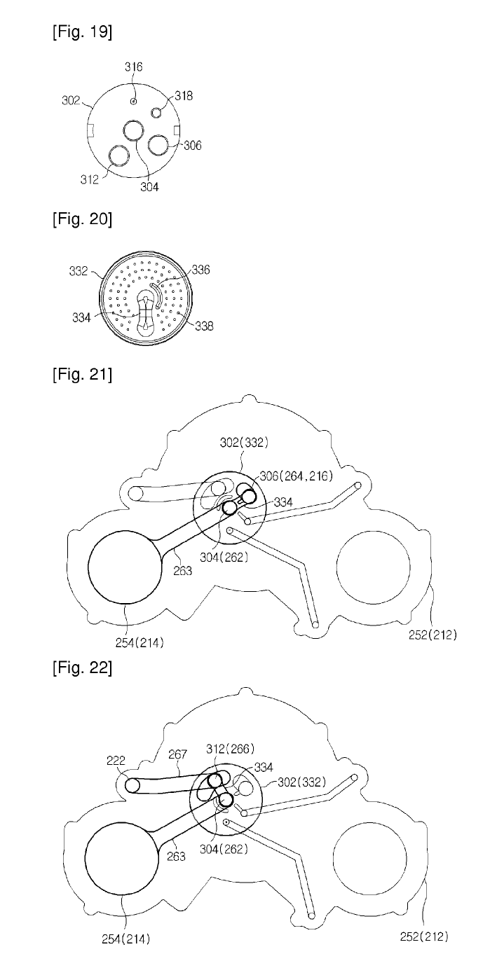

FIGS. 18 and 19 are a plan view and a bottom view of the fixing disk 302, respectively. Reference is made to FIGS. 18 and 19 in conjunction with FIGS. 15 and 16.

As shown in the figures, the fixing disk 302 is formed with first to fifth fixing holes 304, 306, 312, 316 and 318. The second to fifth fixing holes 306, 312, 316 and 318 are disposed in circle around the first fixing hole 304. The first fixing hole 304 is connected to the second passage hole 262, the second fixing hole 306 is connected to the third passage hole 264, the third fixing hole 312 is connected to the fourth passage hole 266, the fourth fixing hole 316 is connected to the fifth passage hole 268, and the fifth fixing hole 318 is connected to the sixth passage hole 272. In addition, on the top of the fixing disk 302 are provided a first connection groove 308 extending the second fixing hole 306 toward the center of the fixing disk 302, a second connection groove 322 extending the fifth fixing hole 318 toward the center of the fixing disk 302, a first extension groove 307 extending the second fixing hole 306 into an arc shape along the rotation direction of the rotating disk (see 322 in FIG. 17), and a second extension groove 314 extending the third fixing hole 312 into an arc shape along the rotation direction of the rotating disk 322. The first and second extension grooves 307 and 314 extend the corresponding fixing holes 306 and 312 for providing reliable connection with a rotating passage (see 334 in FIG. 20) of the rotating disk 332, which will be described later. The first and second connection grooves 308 and 322 will be described in detail in a later relevant portion.

As can be seen from in these figures, diameters of the fourth and fifth fixing holes 316 and 318 are relatively smaller than those of the first to third fixing holes 302, 306 and 312. Among all of the fixing holes, the fourth fixing hole 316 has the smallest diameter. Preferably, an indent groove (see 317 in FIG. 17) of a predetermined depth is provided along an edge of the fourth fixing hole 316 in which a separate regenerating water cover (see 322 in FIG. 17) formed with a plurality of fine holes (see 324 in FIG. 17) can be inserted. The diameters of the first to fifth fixing holes 304, 306, 312, 316 and 318 have a strong relation with the kind of liquids passing the first to fifth fixing holes 304, 306, 312, 316 and 318. As will be described later, cold/hot raw water transferred to the regeneration tank feed pipe (see T2 in FIG. 6) passes the fourth fixing hole 316, and regenerating water transferred from the regeneration tank discharge pipe (see T3 in FIG. 6) passes the fifth fixing hole 318. In this case, even a small quantity of regenerating water can regenerate ion exchange resin, but if the amount of regenerating water is too large, it may produce an adverse effect. The diameter of the fourth fixing hole 316 is preferably less than several mm, more preferably 0.5 to 2 mm.

FIG. 20 is a bottom view of the rotating disk 332. Reference is made to FIG. 20 in conjunction with FIGS. 18 and 19.

As shown in this figure, a groove-like rotating passage 334 and a separate arc-like auxiliary passage 336 are provided in the bottom of the rotating disk 332. When the rotating disk 332 is rotated, the rotating passage 334 properly connects the first fixing hole 304 to the second to fifth fixing holes 306, 312, 316 and 318 and the auxiliary passage 336 interconnects the first and second connection grooves 308 and 322. In addition, in the bottom of the rotating disk 332 is provided a plurality of oil grooves 338 in which a small quantity of oil is retained for waterproofing and lubrication required when the rotating disk 332 is rotated in a closely adhered manner with the fixing disk 302.

FIGS. 21 to 25 are schematic perspective views illustrating a connection relationship between the tank plate 212, the passage plate 252, the fixing disk 302 and the rotating disk 332 according to the operation modes of the water softener of the invention, in which, for convenience' sake, reference numerals of portions unnecessary for description will be omitted. Reference is made to these figures in conjunction with the above Connection Relationship.

\textcircled{1} Soft Water Mode

FIG. 21 is a schematic view showing the soft water mode, in which the rotating passage 334 of the rotating disk 332 interconnects the first and second fixing holes 304 and 306 of the fixing disk 302.

At this time, the first fixing hole 304 of the fixing disk 302 is connected to the filter tank (see 172 in FIG. 6) via the second passage hole 262 of the passage plate 252 (see (1) in the above Connection Relationship), and the second fixing hole 306 of the fixing disk 302 is connected to the soft water tank (see 182 in FIG. 6) via the third passage hole 264 of the passage plate 252 (see (2) in the above Connection Relationship).

Accordingly, cold/hot raw water transferred from the filter tank 172 is supplied to the soft water tank 182, and cold/hot soft water is transferred to the discharge unit 450.

\textcircled{2} Running Water Mode

FIG. 22 shows the running water mode, in which the rotating passage 334 of the rotating disk 332 interconnects the first and third fixing holes 304 and 312 of the fixing disk 302. At this time, the first fixing hole 304 of the fixing disk 302 is connected to the filter tank (see 172 in FIG. 6) via the second passage hole 262 of the passage plate 252 (see (1) in the above Connection Relationship), and the third fixing hole 312 of the fixing disk 302 is connected to the running water pipe (see T1 in FIG. 6) via the fourth passage hole 266 of the passage plate 252 (see (3) in the above Connection Relationship). Accordingly, cold/hot raw water transferred from the filter tank 172 is supplied to the running water pipe T1, and cold/hot running water is transferred to the discharge unit 450.

\textcircled{3} Regeneration Mode

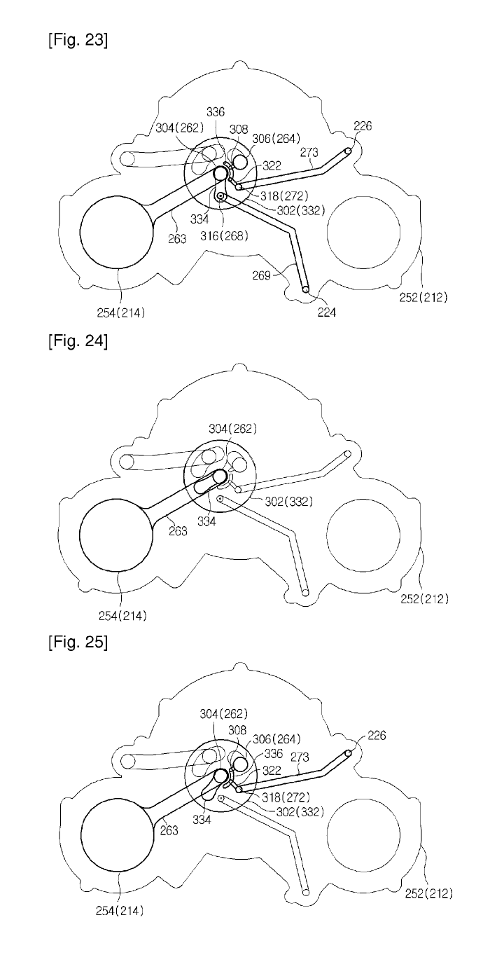

FIG. 23 shows the regeneration mode, in which the rotating passage 334 of the rotating disk 332 interconnects the first and fourth fixing holes 304 and 316 of the fixing disk 302, and the auxiliary passage 336 of the rotating disk 332 interconnects the first and second connection grooves 308 and 322 of the fixing disk 302. At this time, the first fixing hole 304 of the fixing disk 302 is connected to the filter tank (see 172 in FIG. 6) via the second passage hole 262 of the passage plate 252 (see (1) in the above Connection Relationship), and the fourth fixing hole 316 of the fixing disk 302 is connected to the regeneration tank feed pipe (see T2 in FIG. 6) via the fifth passage hole 268 of the passage plate 252 (see (4) in the above Connection Relationship). In addition, the first and second connection grooves 308 and 322 of the fixing disk 302 are respectively connected to the second and fifth fixing holes 306 and 318 of the fixing disk 302. The second fixing hole 306 of the fixing disk 302 is connected to the soft water tank (see 182 in FIG. 6) via the third passage hole 264 of the passage plate 252 (see (2) in the above Connection Relationship), and the fifth fixing hole 318 of the fixing disk 302 is connected to the regeneration tank discharge pipe (see T3 in FIG. 6) via the sixth passage hole 272 of the passage plate 252 (see (4) in the above Connection Relationship). Accordingly, cold/hot raw water transferred from the filter tank 172 is supplied to the regeneration tank feed pipe T2, regenerating water transferred from the regeneration tank discharge pipe T3 is transferred to the soft water tank 182, and regeneration waste water is transferred to the discharge unit 450.

\textcircled{4} Regulation Mode

FIG. 24 shows the regulation mode, in which the rotating passage 334 of the rotating disk 332 is connected to only the first fixing hole 304 of the fixing disk 302. At this time, although the first fixing hole 304 of the fixing disk 302 is connected to the filter tank (see 172 in FIG. 6) via the second passage hole 262 of the passage plate 252 (see (1) in the above Connection Relationship), cold/hot raw water has no further moving path and thus is regulated.

Next, the rinsing mode as the special mode of the water softener of the invention will be described.

\textcircled{5} Rinsing Mode

FIG. 25 is a schematic view showing the rinsing mode.

‘Rinsing mode’ is a unique special mode of the water softener of the invention, which is inevitably concomitant in the process of change from the regeneration mode to the regulation mode. In the rinsing mode, the internal pressure of the regeneration tank (see 192 in FIG. 6) is lowered and relatively low-densed regenerating water is transferred to the soft water tank 182 to rinse the internal of the soft water tank (see 182 in FIG. 6). To this end, the rotating passage 334 of the rotating disk 332 is connected to the first fixing hole 304 of the fixing disk 302, while the auxiliary passage 336 of the rotating disk 332 interconnects the first and second connection grooves 308 and 322 of the fixing disk 302. At this time, the first fixing hole 304 of the fixing disk 302 is connected to the filter tank (see 172 in FIG. 6) via the second passage hole 262 of the passage plate 252 (see (1) in the above Connection Relationship), and the first and second connection grooves 308 and 322 of the fixing disk 302 are respectively connected to the second and fifth fixing holes 306 and 318 of the fixing disk 302. The second fixing hole 306 of the fixing disk 302 is connected to the soft water tank (see 182 in FIG. 6) via the third passage hole 264 of the passage plate 252 (see (2) in the above Connection Relationship), and the fifth fixing hole 318 of the fixing disk 302 is connected to the regeneration tank discharge pipe (see T3 in FIG. 6) via the sixth passage hole 272 of the passage plate 252 (see (4) in the above Connection Relationship). Accordingly, cold/hot raw water transferred from the filter tank 172 is regulated, while regenerating water transferred from the regeneration tank discharge pipe T3 is transferred to the soft water tank 182.

As described earlier with reference to FIGS. 11 and 12, the regenerating water generation unit 580 contained in the regeneration tank 192 transfers regenerating water having the concentration proportional to the supply pressure of cold/hot raw water transferred from the regeneration tank feed pipe T2. As a result, in the rinsing mode, relatively low-densed regenerating water is supplied to the soft water tank 182, through which the internal pressure of the regeneration tank 192 is lowered and the soft water tank 182 is rinsed. Accordingly, a user has not to flow cold/hot soft water for a long time in order to exhaust regenerating water and regeneration waste water remaining in the soft water tank 172 after the regeneration mode. In addition, it is possible to prevent an adverse effect of ion exchange resin which may occur when the water softener is left alone without being used for a long time after the regeneration mode. Moreover, it is possible to use the water softener since the internal pressure of the regeneration tank 192 can be lowered without a separate manipulation by the user.

Subsequently, three convenience modes of the water softener of the invention will be described.

\textcircled{6} Automatic Regeneration Mode

This mode is a mode where the regeneration mode is again changed to the regulation mode via the rinsing mode. Therefore, this mode can be easily understood without a separate figure for this mode. The logical operation unit 602 of the controller 600 determines whether or not a regeneration time of ion exchange resin comes based on the supply amount of cold/hot raw water measured by the measuring unit 120 in the soft water mode, and, if it is determined that the regeneration time comes, controls the motor shaft 394 of the motor 392 and performs the regeneration mode based on a result of detection of the optical sensor 378. In this case, the automatic regeneration mode may be performed in the time zone in which the use amount of cold/hot raw water is not large, for example, during midnight, and progress instruction and time of the automatic regeneration mode may be preset by a user.

\textcircled{7} Flow Rate Control Mode

This mode is a mode where the soft water mode or the running water mode is changed to the regulation mode to discharge the specified amount of cold/hot soft water and cold/hot running water. This mode can be also easily understood without a separate figure for this mode. The flow rate control mode may be used when a bathtube receives water for bath, for example. For this mode, the logical operation unit 602 may include a timer by use of which cold/hot soft water or cold/hot running water is received by the desired amount for a desired period of time. To this end, a user selects the kind of amount of water by means of the input unit 604 and the display unit 606 of the controller 600, and the logical operation unit 602 controls the motor shaft 394 of the motor 392 based on a result of detection of the measuring unit 120, proceeds to the soft water mode or the running water mode to discharge the corresponding amount of cold/hot soft water or cold/hot running water based on a result of detection of the optical sensor 378, and then switches the soft water mode or the running water mode to the regulation mode. In this case, if necessary, the user can also select the temperature of water by means of the input unit 604 and the display unit 606 of the controller 600, and the logical operation circuit 602 can control the motor 392, based on a result of detection of the measuring unit 120, to discharge the corresponding amount of cold/hot soft water or cold/hot running water at the corresponding temperature in the soft water mode or the running water mode, and then switch the soft water mode or the running water mode to the regulation mode.

\textcircled{8} Safety Mode

This mode is a mode where the soft water mode or the running water mode is automatically changed to the regulation mode if the temperature of cold/hot raw water measured by the measuring unit 120 becomes more or less than a preset reference value. This mode can be also easily understood without a separate figure for this mode. In this case, a user may input the reference value in advance by means of the input unit 604 and the display unit 606. Since the water softener of the invention uses one soft water tank 172, if water temperature is suddenly changed in use, water has to flow out for a long time until the water arrives at an intended temperature. The safety mode allows reduction of water consumption and prevention of scald danger and unpleasant feeling due to sudden temperature change. To this end, similar to the above, the logical operation circuit 602 detects the temperature of cold/hot raw water based on a result of detection of the measuring unit 110, controls the motor shaft 394 of the motor 392, and then switches the soft water mode or the running water mode to the regulation mode based on a result of detection of the optical sensor 378.

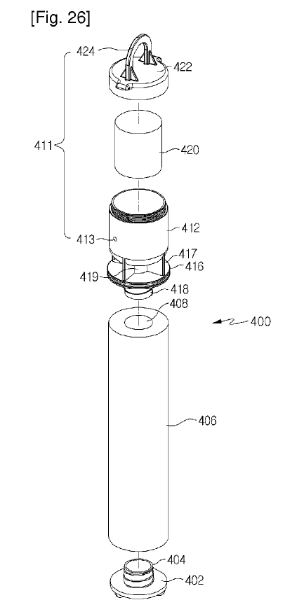

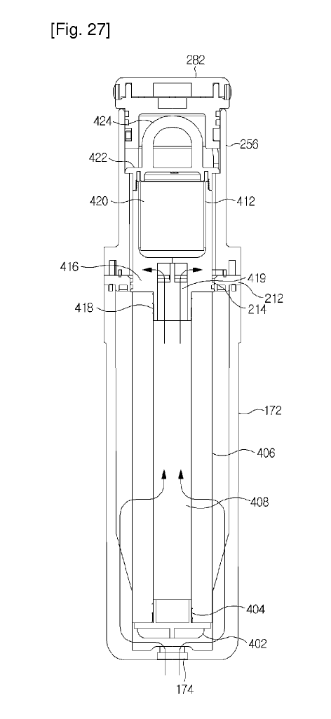

FIG. 26 is an exploded perspective view of the filter unit contained in the filter tank of the water softener of the invention, and FIG. 27 is a sectional view of the filter tank 172 in which the filter unit 400 is contained, which is taken along line A-A in FIG. 3.

The filter unit 400 may not only filter impurities out of cold/hot raw water passing the filter tank 172 but also contain water-soluble functional substance such as vitamins in the cold/hot raw water for user's skin care. To this end, the filter unit 400 may include a filter body 406 which is inserted in the filter tank 172 and filters impurities out of cold/hot raw water, and a functional tank 411 which is filled with functional substance 420 such as vitamins, inserted in the filter tank flange 256 at the top of the filter tank 172, and contains an aqueous solution of the functional substance in the cold/hot raw water passing the filter body 406.

The filter body 406 has a cylinder shape and is composed of fine structural material such as fiber or synthetic resin to filter out impurities out of water. First and second filter guides 402 and 416 are combined to the bottom and top of the filter body 406, respectively. A hollow 408 is formed in the filter body 406 along the longitudinal direction of the filter body 406, and the outer side of the filter body 406 is spaced from the inner side of the filter tank 172. The first filter guide 402 combined to the bottom of the filter body 406 has a shape of plate which is spaced from the filter tank feed hole 174 and substantially seals the bottom of the filter body 406, and includes a first flange 404 inserted in the hollow 408. The second filter guide 416 combined to the top of the filter body 406 has a shape of plate which is closely adhered to the top of the filter body 406, and includes a second flange 418 inserted in the hollow 408. The second filter guide 416 is formed with a raw water hole 419 which extends the hollow 408 and is tightly inserted in the first tank hole 214 of the tank plate 212.

Accordingly, when the filter body 406 is inserted in the filter tank 172, the inside of the filter tank 172 is divided into an outer side of the filter body 406, which is connected to the filter tank feed hole 174, and an inner side of the filter body 406, which is connected to the first tank hole 214. As a result, while cold/hot raw water transferred into the filter tank 172 via the filter tank feed hole 174 is moved from the outer side of the filter body 406 into the hollow 408 in the inner side of the filter body 406, impurities are filtered out of the cold/hot raw water. Thereafter, the cold/hot raw water is transferred to the switch valve assembly 300 via the raw water hole 419 of the second filter guide 416, the first tank hole 214 of the tank plate 212, and the first passage hole 254 and first passage 263 of the passage plate 252 (see FIGS. 13 to 16).

Next, the functional tank 411 inserted in the filter tank flange 256 at the top of the filter body 406 may include a bowl-like tank body 412 and a tank cap 422 joined by screw to the tank body 412 to seal the top of the tank body 412. The tank body 412 is filled with the functional substance 420 such as vitamins. The tank body 412 may be integrally fixed to a plurality of jaws 417 projecting upward from the second filter guide 416, so that the tank body 412 can be spaced from the second filter guide 416 in order not to disturb flow of cold/hot raw water, and a fine outflow hole 413 is formed in one side of the tank body 412. Accordingly, when the filter tank 172 and the filter tank flange 256 are filled with cold/hot raw water, the aqueous solution of the functional substance 420 is flown out via the fine outflow hole 413 and is contained in the cold/hot raw water transferred to the switch valve assembly 300. Since even a small quantity of vitamins as the functional substance contained in the cold/hot raw water shows a sufficient effect, the diameter of the fine outflow hole 413 may be less than 1 mm. In addition, the tank cap 422 may be provided with a separate knob 424 to draw/insert the functional substance 420 from/in the filter tank flange 256 after opening the filter tank cap 282.

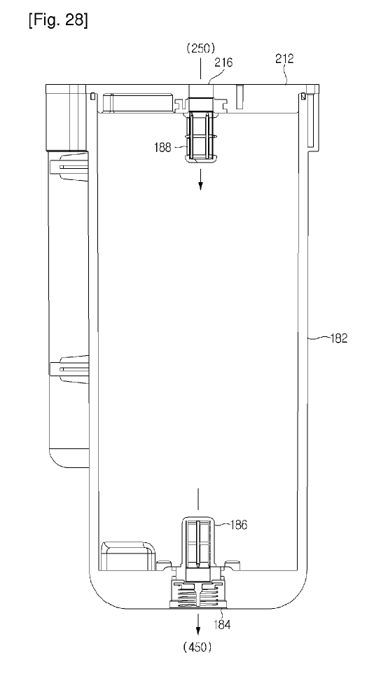

FIG. 28 is a sectional view of the soft water tank 182 of the water softener of the invention, which is taken along line B-B in FIG. 6.

As shown in FIG. 28, first and second check valves 186 and 188 are respectively provided in the soft water tank inflow hole 194 of the soft water tank 182 and the second tank hole 216 of the tank plate 212. The first check valve 186 allows one directional flow of cold/hot soft water and regeneration waste water transferred to the discharge unit 450 via the soft water tank inflow hole 194 in order to prevent the cold/hot soft water and regeneration waste water of the discharge unit 450 from flowing backward toward the soft water tank 182, and the second check valve 188 allows one directional flow of cold/hot raw water introduced into the soft water tank 182 via the second tank hole 216 of the tank plate 212 in order to prevent cold/hot soft water in the soft water tank 182 from flowing backward toward switch valve unit 250.

Hereinafter, a housing in which the controller is mounted and a final exterior case for production, which are parts for completing an external appearance of the water softener 100 of the invention, will be described.

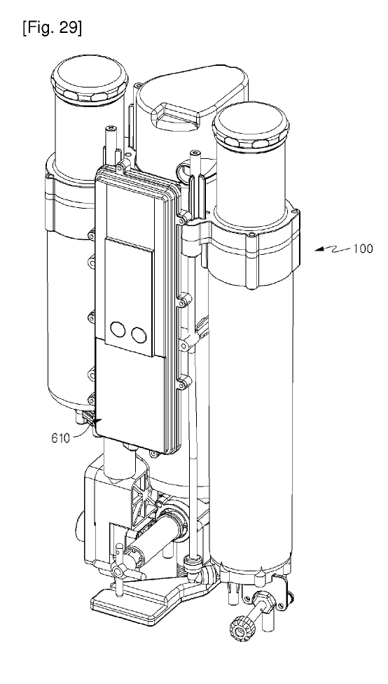

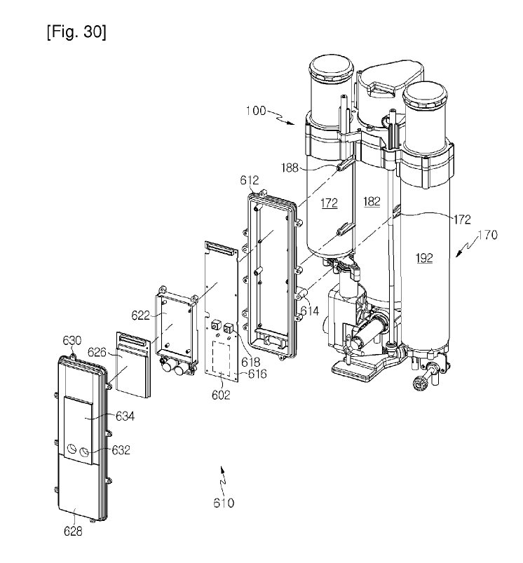

FIG. 29 is a perspective view showing a state where a housing 610 is mounted on the water softener 100 of the invention, and FIG. 30 is an exploded perspective view showing a disassembled state of the housing 610.

As shown in the figures, the housing 610 includes a rear housing 612 fixed to the front side of the soft water tank 182 and a front housing 628 covering the front side of the rear housing 612.

A PCB (Printed Circuit Board) 616 on which the logical operation unit 602 of the controller 600 is mounted is placed between the rear housing 612 and the front housing 628. The input unit 604 including a plurality of buttons 618 and the display unit 606 including an LCD 626, which are other constituent elements of the controller 600, are also mounted on the PCB 616. The LCD 626 may be mounted on a separate LCD case 622 which is in turn mounted on the PCB 616. A transparent window 634 to expose display contents of the LCD 626 to the outside is formed in a portion of the front housing 628. The window 634 is formed with a plurality of button holes 632 to expose the buttons 618. A plurality of first and second joining projections 614 and 630 formed with screw holes projects from edges of the rear housing 612 and the front housing 628 and a plurality of joining ribs 188 formed with nut holes are provided in the front side of the tank unit 170, so that the rear housing 612 and the front housing 628 are combined together and fixed to the front side of the soft water tank 182. Accordingly, the housing 610 is closely fixed to the front side of the soft water tank 182 by means of a plurality of screws inserted in the joining ribs 188 through the first and second joining projections 614 and 630.

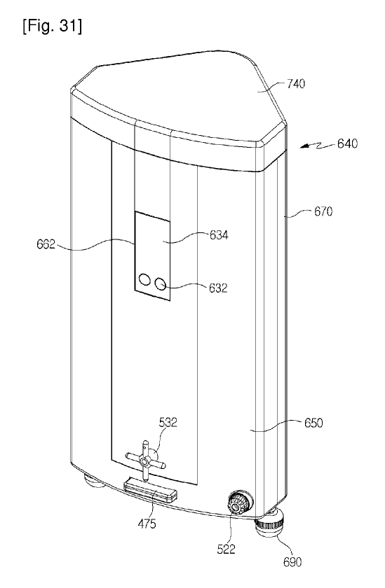

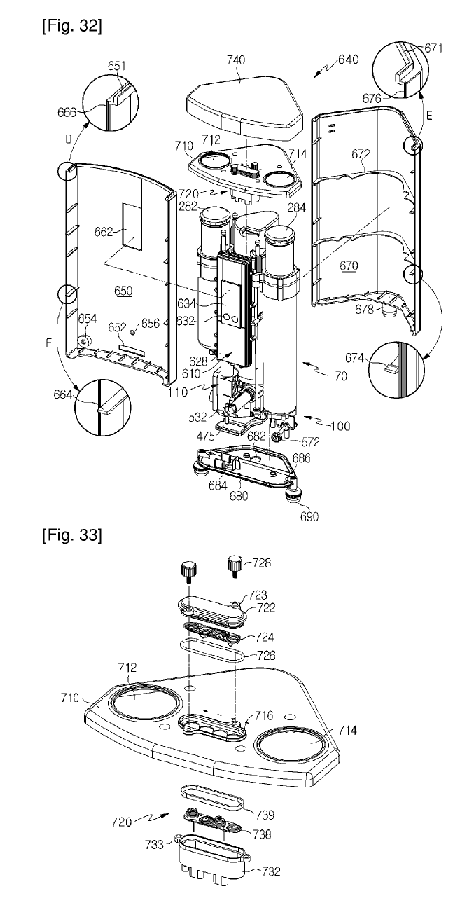

FIG. 31 is a perspective view of an external appearance of the water softener 100 of the invention, and FIG. 32 is an exploded perspective view of an exterior case 640 of the water softener 100.

As shown in the figures, the exterior case 640 of the water softener 100 of the invention may be divided into five parts which are combined into the external appearance shown in FIG. 31.

Specifically, the exterior case 640 includes a front case 650 covering the front side of the water softener 100, a rear case 670 covering the rear side of the water softener 100, a bottom case 680 covering the bottom side of the water softener 100, a middle case 710 covering the top of the water softener 100 except for the filter tank cap 282 and the regeneration tank cap 284, and a top case covering the top of the middle case 710.

First, the front case 650 covers the front side, portions of left and right sides, and a portion of the bottom of the water softener 100. The front case 650 is provided with a first opening 652 to expose the hydrant 475, a second opening 654 to expose the drain handle 572, a third opening 656 to expose the control handle 532, and a fourth opening 662 to expose the button holes 632 and the transparent window 634 of the housing 610. Accordingly, a user can handle the water softener 100 without difficulty.

Next, the rear case 670 covers the rear side, portions of left and right sides, and a portion of the bottom of the water softener 100, and contacts the left and right side of the front case 650. The rear case 670 has a shape vertically bent in its left and right sides with respect to its middle portion such that the rear case 670 can be adhered closely along a corner in a bathroom or the like having two walls intersecting with each other. In addition, in an inner side of the rear case 670 are provided a plurality of reinforcing ribs 672 adhered closely along the rear side of the water softener 100 to prevent the rear case 670 from being deformed due to load or external pressure. In the bottom of the rear case 670 is provided at least one support 678 mounted in an edge of a bathtube or the like. Accordingly, a combination of the front case 650 and the rear case 670 shows a triangular prism or a similar shape covering the front and rear sides of the water softener 100.

The exterior case 640 including the above-described front case 650 and rear case 670 may be manufactured by injection molding of synthetic resin and its thickness may be several mm or so in order to minimize increase of load. As a result, the front case 650 and the rear case 670 may be separated or deviated from each other due to external pressure. Accordingly, a fitting projection 666 may project along left and right ends of the front case 650, as shown in a circled figure D, and a fitting hole 676 may be provided along left and right ends of the rear case 670 contacting and connecting to the left and right ends of the front case 650, as shown in a circled figure E. Engagement of the fitting projection 666 with the fitting hole 676 allows prevention of the front case 650 and the rear case 670 from being deviated from each other. In addition, a plurality of first hook joining ends 664 may project from left and right inner sides of the front case 650, as shown in a circled figure F, and a plurality of corresponding second hook joining ends 674 may project from left and right inner sides of the rear case 670. Engagement of the first hook joining ends 664 with the second hook joining ends 674 allows tight combination of the front case 650 and the rear case 670.

Next, the bottom case 680 covers the bottom of the water softener 100 and is combined to the bottoms of the front case 650 and the rear case 670. The bottom case 680 is formed with first to third holes 682, 684 and 686 to expose the inlet port 124, the shower head connection port 476 and the drain outlet port 564, respectively. In addition, in the bottom of the bottom case 680 are placed at least two height adjusting parts 690 mounted in an edge of a bathtube or the like along with the support 678 of the rear case 670. These height adjusting parts 690 are placed in pair in both left and right sides of the bottom case 680 to show a triangular arrangement along with the support 678.

Next, the middle case 710 is formed with first and second cap holes 712 and 714 to cover the top of the water softener 100 except for the filter tank cap 282 and the regeneration tank cap 284, and the bottom of the middle case 710 is combined to the tops of the front case 650 and the rear case 670. To this end, on the tops of the front case 650 and the rear case 670 are provided first and second hooks (see 651 and 671 in the circled figures D and E) that are introverted and then moved upward, and the bottom of the middle case 710 covers the first and second hooks 651 and 671. In addition, in the middle case 710 is provided a battery case 720 to supply driving power to the controller 600 mounted on the housing 610, which will be described in detail in a relevant portion.

Finally, the top case 740 covers the middle case 710 to finally conceal the top of the water softener 100. As the top case 740 is frequently opened for exchange of the filter unit 400, replacement or injection of regeneration material, replacement of a battery, etc., the top case 740 may have a simple shape to cover the middle case 710.

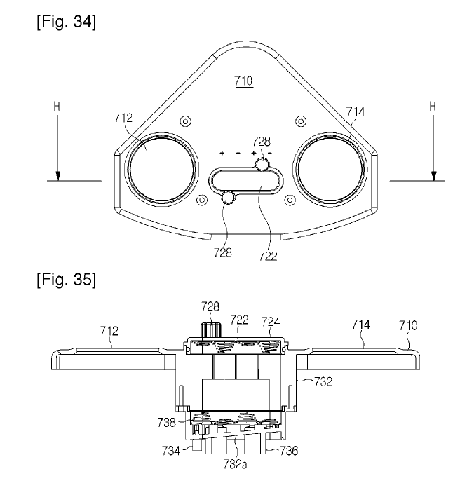

FIG. 33 is an exploded perspective view of the middle case 710, FIG. 34 is a plan view thereof, and FIG. 35 is a sectional view taken along line H-H in FIG. 34.

As shown in the figures, the middle case 710 is formed with the first and second cap holes 712 and 714 and is separately mounted with the battery case 720.

To this end, the middle case 710 is formed with a battery insertion hole 716 sealed by a battery cap 722, and a case body 732 is combined to the bottom of the middle case 710 to provide a battery insertion space. The battery insertion space has the battery insertion hole 716 opened/closed by the battery cap 722, as an entrance. A first terminal 724 to electrically interconnect batteries is disposed in the bottom of the battery cap 722. A pair of first screw coupling ends 723 laterally projects from the side of the battery cap 722. Accordingly, the battery cap 722 is decoupled or coupled by means of a pair of screws 728 inserted into the middle case 710 through the screw coupling ends 723. In order to prevent water or moisture from being introduced into the battery insertion space, a first insulating packing 726 is interposed between the battery cap 722 and the battery insertion hole 716. The pair of screw coupling ends 723 are disposed in an asymmetrical manner to prevent poles of batteries from being connected wrong. The case body 732 is combined to the bottom of the middle case 710 to complete the battery insertion space. At least one pair of second screw coupling ends 733 laterally projects from the top of the case body 732, and a second terminal 738 to electrically interconnect batteries is disposed in the inner bottom of the case body 732. Accordingly, the case body 732 can be also decoupled or coupled by means of screws inserted into the middle case 710 through the second screw coupling ends 733. Also, in order to prevent water or moisture from being introduced into the case body 732, a second insulating packing 739 is interposed between the case body 732 and the middle case 710.

In the meantime, as shown in FIG. 35, the bottom 732a of the case body 732 is inclined to one side with a gap of more than 2 mm maintained from the horizontal second terminal 738, and a water drain hole 734 is provided at the lowest point of the bottom 732a. Accordingly, even when water is introduced into the battery insertion space in the course of replacement of a battery, the water can be quickly drained out. Here, the reason why the point in the bottom 732a of the case body 732, which is the closest to the second terminal 738, maintains a gap of more than 2 mm from the second terminal 738 is to prevent drain of waterdrop from being disturbed due to surface tension or the like. Reference numeral 736 not described refers to a power cable drawing-out port 736 to connect the second terminal 738 to the controller 600 of the housing 610 in order to supply battery driving power.

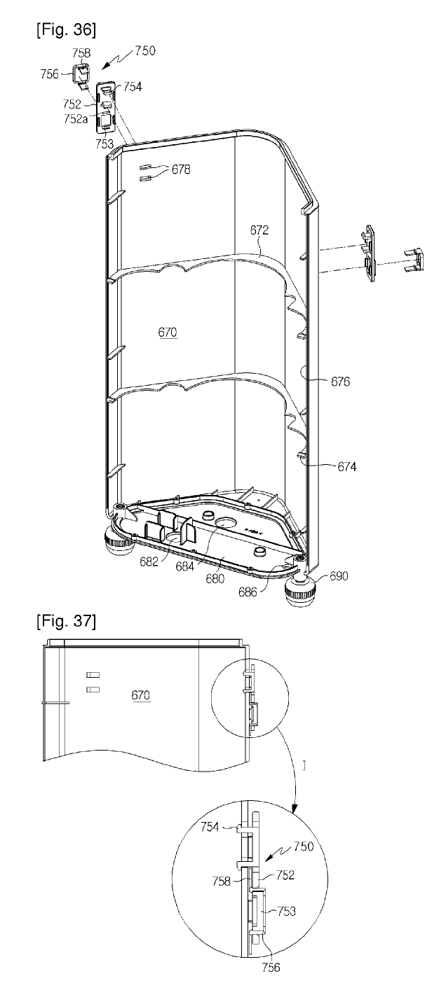

FIGS. 36 and 37 are views for explaining how the water softener of the invention is fixed, FIG. 36 being an exploded perspective view of a hanger 750 viewed separated from the exterior case 610, and FIG. 37 being a sectional view of a combined state of the hanger 750.

The water softener of the invention can be installed at a corner of a bathroom or the like, as described earlier, and the separate hanger 750 may be used to stably fix the water softener at the corner. To this end, a pair of hanger holes 678 are formed in left and right tops of the rear case 670 adhered closely to a wall. The hanger 750 includes a hanger frame 752 adhered closely to the rear case 670 and a moisture interruption packing 756 inserted in the outer side of the hanger frame 752.

In the inner side of the hanger frame 752 is provided at least one fixing hook 754 which is inserted in and hooked onto the hanger holes 678. In addition, an adhesion plane 753 to be adhered to a wall by means of a double-sided tape or the like projects from the outer side of the hanger frame 752. As the moisture interruption packing 756 is adhered closely to the wall, surrounding the outer side of the adhesion plane 753, the adhesion strength of the double-sided tape is prevented from being deteriorated due to moisture. In this case, if necessary, slit-shaped packing grooves 752a may be provided at both sides of the adhesion plane 753 of the hanger frame 750, and extension ends 758 may be respectively inserted in the packing grooves 752a and may be bent and interposed between the hanger frame 752 and the rear case 670. This may produce a certain elastic force exerted between the rear case 670 and the hanger frame 752 in order to reinforce a fixing strength by the fixing hook 752 and may effectively prevent moisture from being permeated into the adhesion plane 753.

1-38. (canceled)

39. A water softener comprising:
a tank unit including a filter tank to filter impurities out of cold/hot raw water, a soft water tank filled with an ion exchange resin, and a regeneration tank filled with a regeneration material for regenerating the ion exchange resin;
a feed unit for feeding the cold/hot raw water supplied from external into the filter tank;
a discharge unit for discharging cold/hot soft water, the cold/hot raw water as cold/hot running water and regeneration waste water; and
a switch valve unit for performing a soft water mode in which the cold/hot raw water of the filter tank is transferred to the soft water tank to be softened by the ion exchange resin and the generated cold/hot soft water is transferred to the discharge unit, a running water mode in which the cold/hot raw water of the filter tank is transferred to the discharge unit as the cold/hot running water, a regeneration mode in which the cold/hot raw water of the filter tank is transferred to the regeneration tank to be used in generating regenerating water by the regeneration material and then the regenerating water is transferred to the soft water tank to be used in regenerating the ion exchange resin and then the regeneration waste water generated in the regeneration of the ion exchange resin is transferred to the discharge unit, a regulation mode in which the cold/hot raw water of the filter tank is regulated, and a rinsing mode between the regeneration mode and the regulation mode in which the ion exchange resin is rinsed by the regeneration water which has relatively low density.

40. The water softener according to claim 39,
wherein the switch valve unit transfers the regenerating water of the regeneration tank to the soft water tank with regulation of supply of the cold/hot raw water in the rinsing mode.

41. The water softener according to claim 40, further comprising
a filter tank discharge pipeline for interconnecting the filter tank and the switch valve unit and transferring the cold/hot raw water of the filter tank to the switch valve unit;
a running water pipeline for interconnecting the switch valve unit and the discharge unit and transferring the cold/hot raw water of the switch valve unit as the cold/hot running water to the discharge unit;
a regeneration tank feed pipeline for interconnecting the switch valve unit and the regeneration tank and transferring the cold/hot raw water of the switch valve unit to the regeneration tank;
a regeneration tank discharge pipeline for interconnecting the regeneration tank and the switch valve unit and transferring the regenerating water of the regeneration tank to the switch valve unit;
a soft water tank feed pipeline for interconnecting the switch valve unit and the soft water tank and transferring the cold/hot raw water and the regenerating water of the switch valve unit to the soft water tank; and
a soft water tank discharge pipeline for interconnecting the soft water tank and the discharge unit and transferring the cold/hot soft water and the regeneration waste water of the soft water tank to the discharge unit.

42. The water softener according to claim 41, wherein the switch valve unit includes:
a motor;
a fixing disk formed with a plurality of fixing holes respectively corresponding to the filter tank discharge pipeline, the running water pipeline, the regeneration tank feed pipeline, the regeneration tank discharge pipeline, and the soft water tank feed pipeline; and
a rotating disk that is rotated by the motor with close adhesion to the fixing disk and includes rotating passages for interconnecting the filter tank discharge pipeline and the soft water tank feed pipeline in the soft water mode, interconnecting the filter tank discharge pipeline and the running water pipeline in the running water mode, interconnecting the filter tank discharge pipeline and the regeneration tank feed pipeline and interconnecting the regeneration tank discharge pipeline and the soft water tank feed pipeline in the regeneration mode, regulating the filter tank discharge pipeline in the regulation mode, and regulating the filter tank discharge pipeline and interconnecting the regeneration tank discharge pipeline and the soft water tank feed pipeline in the rinsing mode.

43. The water softener according to claim 41, further comprising:
a regenerating water generating unit contained in the regeneration tank for transferring the regenerating water to the regeneration tank discharge pipeline when the cold/hot raw water is transferred to the regeneration tank feed pipeline.

44. The water softener according to claim 43,
wherein the regenerating water generating unit has a mesh shape formed with a plurality of fine holes for interconnecting the regeneration tank feed pipeline and the regeneration tank discharge pipeline and include therein a through hole to suddenly reduce an inner diameter of the regenerating water generating unit and transfers the regenerating water, which has concentration proportional to the supply pressure of the cold/hot raw water transferred to the regeneration tank feed pipeline, to the regeneration tank discharge pipeline.

45. The water softener according to claim 39, further comprising:
a filter unit contained in the filter tank for filtering impurities out of the cold/hot raw water.

46. The water softener according to claim 45,
wherein the filter unit contains a water-soluble functional material which is dissolved in the cold/hot raw water after the impurities of the cold/hot raw water has been filtered out.

47. The water softener according to claim 46,
wherein a filter tank feed hole through which the cold/hot raw water of the feed unit is fed is formed in the bottom of the filter tank, a first passage hole through which the cold/hot raw water is transferred to the switch valve unit is formed in the top of the filter tank, and a first tank hole to interconnect the filter tank hole and the first passage hole between the filter tank hole and the first passage hole is formed in the inside of the filter tank, and
the filter unit further includes:
a cylinder-shaped filter body interposed between the filter tank feed hole and the first passage hole and having a hollow formed therein along a longitudinal direction;
a first filter guide sealing the bottom of the filter unit; and
a second filter guide sealing the top of the filter unit with a raw water hole formed therein to extend the hollow and being inserted in the first tank hole.

48. The water softener according to claim 47, wherein the filter unit further includes:
a functional tank that is combined to the top of the filter body, is filled with the water-soluble functional material, and is formed with fine holes at one side of the filter unit.

49. The water softener according to claim 39, wherein the discharge unit includes:
a hydrant;
a shower head; and
a control valve for finally regulating the cold/hot soft water, the cold/hot running water and the regeneration waste water or finally discharging the cold/hot soft water, the cold/hot running water and the regeneration waste water to one or both of the hydrant and the shower head by direct manipulation of a user.

50. The water softener according to claim 39, further comprising:
a triangular prism-shaped exterior case in which the water softener is accommodated, wherein the triangular prism-shaped exterior case is installed in a bathtube edge in a bathroom at which two walls intersect with each other.

51. The water softener according to claim 50, further comprising a controller that controls the switch valve unit with charging power of a plurality of batteries,
wherein the exterior case includes:
a front case that covers the front side of the water softener;
a rear case that covers the rear side of the water softener and is combined to the front case;
a bottom case that covers the bottom of the water softener and is mounted in the bathtube edge;
a middle case that covers the top of the water softener and provides a battery insertion space in which the plurality of batteries are mounted; and
a top case that covers the top of the middle case.

52. The water softener according to claim 51, further comprising:
a battery insertion hole that is formed in the middle case;
a battery cap that is combined to the top of the middle case and covers the battery insertion hole; and
a battery case that is combined to the bottom of the middle case and defines the battery insertion space in the battery case.

53. The water softener according to claim 52, further comprising:
a pair of first screw coupling ends laterally projecting from the battery cap, wherein the battery cap is fixed by a pair of screws inserted in the middle case through the first screw coupling ends.

54. The water softener according to claim 53, further comprising first and second terminals that are respectively fixed in parallel to the inner side of the battery cap and the inner bottom of the battery case and electrically interconnect the batteries,
wherein the bottom of the battery case is inclined to one side far away from the second terminal, and a water drain hole is provided at the lowest point of the bottom of the battery case.

55. The water softener according to claim 54,
wherein a gap between the bottom of the battery case and the second terminal is at least 2 mm.

56. The water softener according to claim 51, further comprising:
a hanger hole that is provided in the rear case; and
a hanger that is interposed between the rear case and the walls and is adhered closely to the walls by means of a double-side tape with the hanger inserted in the hanger hole.

57. The water softener according to claim 56,
wherein the hanger includes:
a hanger plate including a projecting adhesion plane at one side of the hanger plate facing the walls to which the double-sided tape is adhered and a hook coupling end to be inserted in the hanger hole at the other side of the hanger plate facing the rear case; and
a moisture interruption packing that is closely interposed between the hanger plate and the walls, surrounding an edge of the adhesion plane.

58. The water softener according to claim 39,
wherein the feed unit includes a measuring unit for measuring the supply amount and temperature of the cold/hot raw water, and
the switch valve unit further performs a safety mode for switching the soft water mode or the running water mode to the regulation mode when the temperature of the cold/hot raw water is more or less than a reference value.
